(19) United States
(12) Patent Application Publication
(10) Pub. No.: US 2016/0063644 A1
(43) Pub. Date: Mar. 3, 2016

(54) COMPUTER PROGRAM, METHOD, AND SYSTEM FOR DETECTING FRAUDULENTLY FILED TAX RETURNS

(71) Applicant: HRB Innovations, Inc., Las Vegas, NV (US)

(72) Inventors: Mark Ciaramitaro, Leawood, KS (US); Jason Houseworth, Olathe, KS (US)

(21) Appl. No.: 14/692,062

(22) Filed: Apr. 21, 2015

Related U.S. Application Data
(60) Provisional application No. 62/043,600, filed on Aug. 29, 2014.

(51) Int. Cl. G06Q 40/00

(52) U.S. Cl. CPC G06Q 40/123

(57) ABSTRACT

Embodiments of the invention detect fraudulently filed tax returns when a subject taxpayer submits a subject tax return for filing with a taxing authority. Embodiments analyze tax information associated with the subject tax return and compare the information against tax information of previously filed tax returns for a plurality of taxpayers. These embodiments search for confidence indicators among the tax returns indicative or suggestive of at least one fraudulent tax return. These confidence indicators are then analyzed to determine if the subject tax return for the subject taxpayer, any of the previously filed tax returns, or some combination thereof, is a fraudulent tax return.

### RELATED APPLICATIONS

This non-provisional patent application claims priority benefit, with regard to all common subject matter, of U.S. Provisional Patent Application No. 62/043,600, filed Aug. 29, 2014, and titled “COMPUTER PROGRAM, METHOD, AND SYSTEM FOR DETECTING FRAUDULENTLY FILED TAX RETURNS.” The identified earlier-filed provisional patent application is hereby incorporated by reference in its entirety into the present application.

Embodiments and/or features of the invention described in the present document may be used with the subject matter disclosed in commonly assigned and concurrently filed U.S. patent application Ser. No. ______, filed Apr. 21, 2015, and entitled “COMPUTER PROGRAM, METHOD, AND SYSTEM FOR DETECTING FRAUDULENTLY FILED TAX RETURNS.” The concurrently filed patent application is hereby incorporated by reference in its entirety into the present application.

### BACKGROUND

1. Field

Embodiments of the invention relate to fraud prevention in the field of electronically filed tax returns.

2. Related Art

Government taxing authorities, such as the U.S. Internal Revenue Service, require a taxpayer to file a tax return with the taxing authority for a specified tax period, such as a calendar year. The tax return sets forth tax information associated with the taxpayer, such as the taxpayer's name, address, social security number, wages, retirement investments, capital gains and losses, dependents, etc. The taxpayer commonly owes taxes to the government taxing authority. In many instances, the taxes are withdrawn from the taxpayer's payroll via income tax withholdings. However, in some instances, the taxpayer may receive a tax refund based on the tax liability of the taxpayer in comparison to any income tax withholdings throughout the tax period. Because of the opportunity to receive a tax refund from the government taxing authority, a malfeasant may seek to file a fraudulent tax return.

In some instances, the fraudulent tax return includes tax information for a legitimate taxpayer, such as the taxpayer's social security number and address. However, to receive the tax refund, the fraudulent tax return may include false information, such as a bank deposit account number for the malfeasant and not for the taxpayer. In such an instance, the government taxing authority disburses the tax refund to the malfeasant's bank account and not the bank account of the legitimate taxpayer. This instance may occur in both the fraudulent tax return being the first-filed or later-filed tax return. That is, in the instance where the fraudulent tax return is the first-filed tax return, the government taxing authority has no way of determining that at least some of the tax information associated with the fraudulent tax return is indeed false. Thus, the government taxing authority may unknowingly disburse the tax refund to the malfeasant. In the instance where the fraudulent tax return is the later-filed tax return, i.e., the legitimate taxpayer first-filed their legitimate tax return, the government taxing authority may still not know that the second, later-filed tax return is fraudulent due to poor cross-referencing and tracking of filed tax returns.

In recent years, tax fraud has become increasingly rampant. In 2014, the IRS reported that it caught $24.5 billion of fraudulent tax returns, and that it estimates to have paid an additional $5.5 billion in fraudulent tax returns. The increase in tax fraud can be linked to identity theft and data breaches, in which the taxpayer's personal information becomes compromised. The increase can also be linked to lax standards and verification by taxing authorities. For example, some malfeasants will file tax returns with multiple states because the various states do not share information together to help combat tax fraud. What is lacking in the prior art is a comprehensive way to detect fraudulent tax returns and fraudulent users.

### SUMMARY

Embodiments of the invention detect fraudulently filed tax returns. In general, when a user submits a subject tax return that relates to a subject taxpayer for filing with a government taxing authority, embodiments of the invention analyze tax information associated with the subject tax return and compare the information against tax information of previously-filed tax returns for a plurality of taxpayers. In embodiments, all of the plurality of taxpayers is different than the subject taxpayer. In alternative embodiments of the invention, at least a portion of the plurality of taxpayers is different than the subject taxpayer. These embodiments search for confidence indicators among the tax returns. These confidence indicators are then analyzed to determine if the subject tax return for the subject taxpayer, any of the previously filed tax returns, or some combination thereof, is a fraudulent tax return.

Embodiments of the invention are generally directed to a non-transitory computer-readable storage medium having a computer program stored thereon for detecting a fraudulently filed tax return. The computer program instructs at least one processing element to perform the following steps: receiving tax information associated with a subject tax return for a subject taxpayer; accessing a filed return data store comprising tax information associated with a plurality of previously filed tax returns for a respective plurality of taxpayers, wherein the each of the plurality of previously filed tax returns is associated with a tax period that is the same as, or in alternative embodiments different than, a tax period associated with the subject tax return for the subject taxpayer; comparing the received tax information associated with the subject tax return for the subject taxpayer with said accessed tax information from the filed return data store; and identifying, based on said comparison, at least one confidence indicator for the subject tax return, wherein said at least one confidence indicator is indicative of a fraudulent tax return for the subject taxpayer.

Embodiments of the invention are directed to a computerized method for detecting fraudulent tax returns by performing the above-mentioned steps.

Embodiments of the invention are also generally directed to a system for detecting a fraudulent tax return, the system comprising: a filed return data store comprising filed tax information indicative of a plurality of previously filed tax returns for a corresponding plurality of filed taxpayers; and a return verification engine that acquires subject tax information indicative of a subject tax return to be verified, wherein the subject tax return is associated with a tax period, wherein the return verification engine accesses the filed tax information associated with said tax period from the filed return data store, wherein the return verification engine compares the subject tax information to the filed tax information to identify at least one confidence indicator, and wherein said at least one confidence indicator is indicative of a fraudulent tax return for the subject taxpayer.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a flow diagram of a first exemplary embodiment of the invention, illustrating the various components of a system for detecting fraudulent tax returns by identifying confidence indicators and calculating a taxpayer identity confidence score;

FIG. 2 is a flow diagram of a second exemplary embodiment of the invention;

FIG. 3 is a flow diagram of a third exemplary embodiment of the invention;

FIG. 4 is a flow diagram of an exemplary embodiment of the invention, illustrating how the taxpayer identity confidence score is utilized;

FIG. 5 is a flow diagram of exemplary analysis performed before the entry of tax data by a user;

FIG. 6 is a flow diagram of exemplary analysis performed during the entry of tax data by the user;

FIG. 7 is a flow diagram of exemplary analysis performed after the entry of tax data by the user;

FIG. 8 is a flow diagram illustrating the identification and analysis of confidence indicators in a subject tax return;

FIG. 9 is a flow diagram illustrating an exemplary authentication of a subject taxpayer;

FIG. 10 is a flow diagram illustrating an exemplary determination of a fraud risk level for a subject taxpayer; and

FIG. 11 is a system diagram of an embodiment of the invention depicting various computing devices and their components.

The drawing figures do not limit embodiments the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein. It should also be noted that the subtitled sections within the Detailed Description are for the purpose of orienting the reader and should not be construed in a limiting sense.

Embodiments of the invention comprise a computer program, a computerized method, and a system for detecting fraudulent tax returns. Embodiments of the invention analyze tax returns before, during, or after filing with a government taxing authority to help ensure that the tax return is genuine (i.e., legitimate and not fraudulent). Embodiments of the invention verify the tax returns in a wide variety of techniques, as discussed in depth below. Each technique determines various confidence indicators that are indicative of a level of confidence that at least one tax return is either fraudulent or genuine. Based upon the techniques and the determined confidence indicators, embodiments of the invention calculate or otherwise determine a taxpayer identity confidence score. The taxpayer identity confidence score is a summary of the likelihood that the subject tax return is either fraudulent or genuine. Based upon the taxpayer identity confidence score, the tax return may be submitted to the taxing authority, further authenticated, denied acceptance, denied transmission, quarantined, flagged for further investigation, etc.

### System Overview

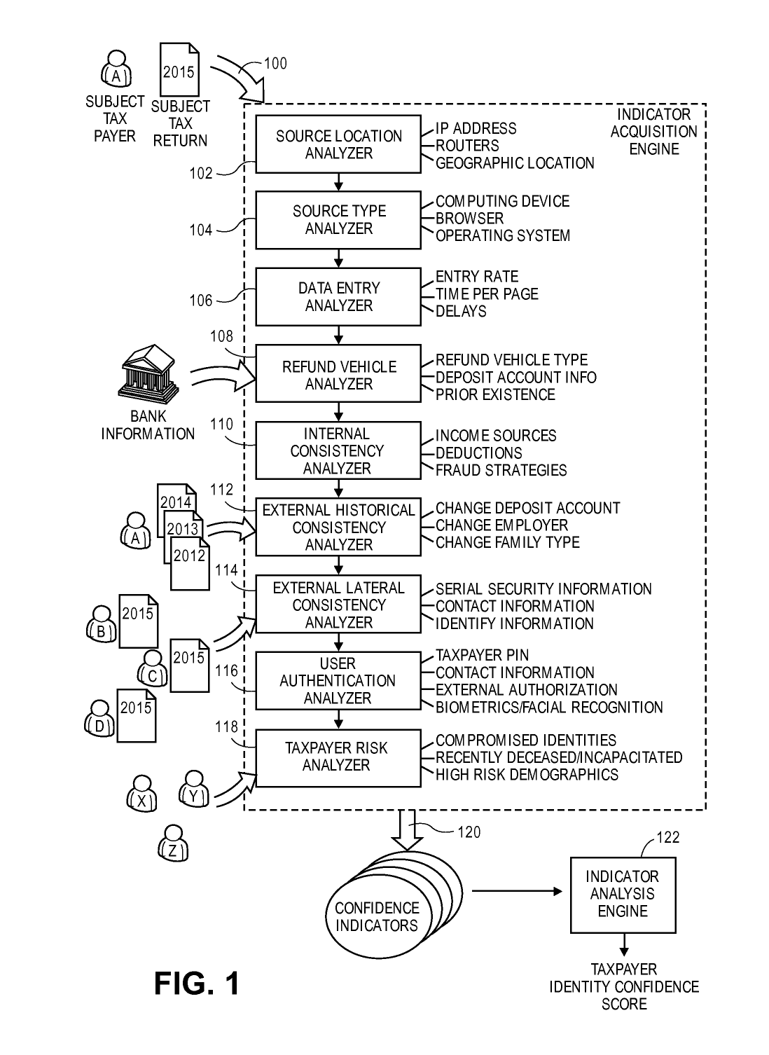

Turning to the figures, an exemplary embodiment of the invention is illustrated in FIG. 1. Broadly, FIG. 1 shows the identification of confidence indicators and the analysis of those confidence indicators to determine a taxpayer identity confidence score. In Step 100, an indicator acquisition engine receives information about a subject taxpayer (labeled “A”) and a subject tax return (labeled “2015” as an exemplary tax year to which the subject tax return relates). This information may further include information related to the user and a computing device utilized by the user, as discussed below. The indicator acquisition engine evaluates the information and draws on other external sources of information to determine a plurality of confidence indicators. Confidence indicators are, generally speaking, measures of the probability or likelihood that the subject tax return is genuine or fraudulent based upon any or a few factors and analyses discussed in depth below. Confidence indicators may be “positive” in that they are indicative of genuineness or “negative” in that they are indicative of fraud.

The indicator acquisition engine may comprise a plurality of sub-component indicator acquisition analyzers that determine confidence indicators based upon various criteria and sources. In Step 102, a source location analyzer determines confidence indicators related to the source location from which the user is accessing the system. For example, the source location analyzer may consider the Internet Protocol (IP) address, routers and servers through which the user accesses the system, the geographic location where the user is located, etc. In Step 104, a source type analyzer determines confidence indicators related to the computing device from which the user is working. For example, the source type analyzer may consider the type of computing device, a browser used to access the system, an operating system for the device, etc.

In Step 106, a data entry analyzer determines confidence indicators related to the entry of data into the system and/or a tax return preparation program by the user. For example, the data entry analyzer may consider the entry rate of information (i.e., consistent with human typing), the time spent per page or total in the tax return preparation process, whether there are delays in the preparation that would be consistent with a legitimate human preparing their tax return, etc. In Step 108, a refund vehicle analyzer determines confidence indicators related to the selected refund vehicle through which the subject taxpayer will receive their tax refund. For example, the refund vehicle analyzer may consider the type of refund vehicle chosen by the user, the deposit account information, the prior existence or ongoing nature of the refund vehicle, etc. The refund vehicle analyzer may pull in external information from the bank based upon the tax information input. In Step 110, an internal consistency analyzer determines confidence indicators related to characteristics of the tax information or subject tax return that may be consistent with fraud. The internal consistency analyzer looks for fraud on the face of the subject tax return without comparing the tax return to external sources of information. For example, the internal consistency analyzer may consider the income sources, deductions, and credits in comparison to common fraud strategies used by malfeasants.

In Step 112, an external historical consistency analyzer determines confidence indicators related to prior-filed tax returns of the subject taxpayer. The external historical consistency analyzer draws or receives previously filed tax returns (labeled “2012”-“2014” in relation to the exemplary subject tax return for 2015), or related sets of information, that relate to the same subject taxpayer (labeled “A”). For example, the external historical consistency analyzer may consider changes in deposit account information, unusual changes in employment information, and unusual changes in family type and composition. In Step 114, an external lateral consistency analyzer determines confidence indicators related to comparing the subject tax return to other tax returns filed for the current tax year that relate to other taxpayers. The external lateral consistency analyzer draws or receives previously filed tax returns (each labeled “2015,” the same tax period as the subject tax return), or related sets of information, that relate to a plurality of taxpayers (labeled “B”-“D”). In embodiments, all of the plurality of taxpayers is different than the subject taxpayer. In alternative embodiments of the invention, at least a portion of the plurality of taxpayers is different than the subject taxpayer. For example, the external lateral consistency analyzer may consider duplicate social security numbers (SSNs), duplicate contact information, and other duplicate or suspicious identification information.

In Step 116, a user authentication analyzer determines confidence indicators related to the user's ability or inability to authenticate his identity as the subject taxpayer or a person authorized by the subject taxpayer to file the subject tax return. For example, the user authentication analyzer may consider the user's ability to provide an assigned taxpayer personal identification number (typically supplied by the taxing authority), to respond to messages to various known contact information for the subject taxpayer, to provide external authorization, and to submit secondary authorization information such as biometrics and facial recognition data. In Step 118, a taxpayer risk analyzer determines confidence indicators related to likelihood that the subject taxpayer will be or is the victim of identity theft. The taxpayer risk analyzer draws on external information sources, such as elicit marketplaces of stolen identities. For example, the taxpayer risk analyzer may consider compromised identities of taxpayers, recently deceased or incapacitated taxpayers, and whether the subject taxpayer belongs to a high risk demographic.

Based upon all (or some) of the above analyses, in Step 120 the indicator acquisition engine accumulates all of the confidence indicators and submits them to the indicator analysis engine. In Step 122, the indicator analysis engine considers the plurality of confidence indicators and calculates the taxpayer identity confidence score. The indicator analysis engine weighs confidence indicators, compares them together or in discrete groups, and otherwise performs various statistical analyses. The indicator analysis engine analyzes the consistency of the confidence indicators together, as to whether they indicate genuineness or fraud. As discussed below, based upon the taxpayer identity confidence score, the system may take further actions, such as submit the tax return to the taxing authority with information indicative of the taxpayer identity confidence score, deny filing, report the user and/or the subject tax return to an appropriate law enforcement agency, etc.

Before discussing these steps in more detail, terms used herein will be discussed for clarity. The following discussion provides examples and broad, non-limiting discussions of the terms herein.

A “taxpayer” includes any entity, either a legal or natural person, that files a tax return with a government taxing authority. The taxpayer may also be a first spouse and a second spouse filing a joint return. Taxes to be paid can be United States Federal Income Tax, income tax for the various states within the United States, corporate taxes, partnership taxes, LLC taxes, property taxes, tariffs, or other taxes. Typically, the taxpayer provides information relevant to themselves and the amount of tax owed in the form of the tax return. The tax return is discussed more below. It should also be noted that in embodiments of the invention, the taxpayer is instead a beneficiary of a government entitlement program, as discussed below.

The “subject taxpayer,” as used herein, refers to the taxpayer for which the tax return purports to apply. The subject taxpayer is the taxpayer whose name or names and other information appear on the tax return. In most instances, all or most of the subject taxpayer information will relate to a single discernable subject taxpayer (or two discernable natural persons that are spouses of each other). For example, in some instances, a malfeasant will copy subject taxpayer information from a filed tax return, change the bank deposit account information, and submit a new fraudulent tax return. In this example, the subject taxpayer is the taxpayer whose information appears on the filed tax return (whose information was copied from a previously filed tax return). In some instances, the subject taxpayer information is an amalgamation of more than one taxpayer's information. For example, the subject taxpayer information may include a fake name, a stolen Social Security Number, a fake address, and deposit account information for the malfeasant. In some instances, the subject taxpayer information is mostly indicative of a single discernable entity. For example, the subject taxpayer information may include all true information for the subject taxpayer, but also include a physical address or post office box address associated with the malfeasant in an attempt to have the tax return check delivered to that location. In this example, the subject taxpayer is the single discernable entity to which the majority of the information applies.

Embodiments of the invention are generally directed to the detection and identification of malfeasants in the submission of fraudulent tax returns. Malfeasants operate in a number of methods to attempt to receive an illegal tax return. A few of those methods have been and will be briefly discussed for the sake of clarity. However, it should be appreciated that embodiments of the invention are directed to the detection and identification of other methods and types of malfeasants. It should be appreciated that in some instances, the subject taxpayer is a malfeasant. In these instances, the malfeasant may also be the user of the system or the customer of the tax professional. For example, the subject taxpayer may be a malfeasant who deliberately underreports income or claims deductions for which they do not qualify. Many fraudulent tax returns fall into one of two categories: those in which a malfeasant files a tax return comprising at least some personal identification information that belongs to another, and those in which a malfeasant files a tax return comprising a substantially duplicate tax return of a subject taxpayer with altered deposit account information. In both of these categories, the malfeasant is performing illegal acts in an attempt to receive a tax refund amount to which they are not entitled. Embodiments of the invention, as discussed below, may detect fraudulent returns in either, both, or other categories.

The “user” is the person who is utilizing or interacting with the system. The user acts, or purports to act, on behalf of the subject taxpayer. Examples of users include the subject taxpayer, an authorized friend or family member of the subject taxpayer, a tax professional, a financial professional, or a malfeasant. In some embodiments, the user is connected to the system while the discussed steps are performed. In other embodiments, the user is no longer connected to the system while the discussed steps are performed. A user is “genuine” when they either are the subject taxpayer or are someone duly authorized to act on the taxpayer's behalf. A user is “fraudulent” when the user is not authorized by the subject taxpayer and/or preparing and submitting a fraudulent tax return. An “operator” is a person associated with the system, such as an administrator, tax professional, or the like.

The “taxpayer identity confidence score” is an indication of a likelihood that the subject tax return is either genuine or fraudulent. The taxpayer identity confidence score is therefore a snapshot or summary of the analyses and calculations performed by the system in determining whether the subject tax return is fraudulent. The tax professional and/or the taxing authority, in considering whether to file or accept the subject tax return, may consider the taxpayer identity confidence score. For example, a taxing authority may dictate by rule or regulation a minimum acceptable taxpayer identity confidence score for the acceptance of tax returns. In some instances the minimum acceptable taxpayer identity confidence score may be based upon the type of tax return, the type of taxpayer, the time of year, etc. For example, over the course of a tax return filing season (i.e., typically mid-January through April 15th following the current tax year) fraud is more rampant earlier in the tax return filing season. This is because malfeasants are more likely to be detected if the subject taxpayer has already filed their tax return for the tax year. The taxing authority may therefore require a higher minimum acceptable taxpayer identity confidence score early in the tax return filing season.

The taxpayer identity confidence score can be expressed in any of several forms. A first exemplary form is a numerical value. The numerical value could be expressed from −100 to +100, such that −100 is definitely fraudulent and +100 is definitely genuine (intermediate values being in the range of −99 to 0 and 0 to +99). For clarity, throughout the remainder of this application the taxpayer identity confidence score will be discussed using a numerical value from −100 to +100, with a default value (i.e., before any calculations take place) of 0. In other embodiments, the numerical value could be expressed a likelihood from 0-10, such that 0 is definitely fraudulent and 10 is definitely genuine (intermediate values ranging from 0.1 to 9.9 or 1 to 9). In yet other embodiments, the numerical value is a summation of factors with no theoretical maximum or theoretical minimum. A second exemplary form is a letter grade, such as an “F” for definitely fraudulent and an “A” for definitely genuine (intermediate values being “B,” “C,” and “D”—possibly including plusses and minuses). A third exemplary form may be a color system in which red is definitely fraudulent and green is definitely genuine (intermediate values being on the color spectrum between red and green). A fourth exemplary form may be a simple pass/fail designation. The pass/fail designation definitely states whether the system believes the subject tax return to be fraudulent or not. In this and other forms, the system may presume that the subject tax return is fraudulent until the user proves it to be genuine. Another example of the pass/fail designation could be “proven to be genuine,” “not proven to be genuine,” and “proven to be fraudulent.” A fifth exemplary form may be a threshold illustration. For example, the threshold illustration may be a thermometer with the level of the thermometer approximating the likelihood of genuineness and an illustrated threshold above which the user must move the level before being allowed to file the subject tax return. A sixth exemplary form, which may be utilized in addition to one of the above-mentioned forms, may be a user fraud profile. The user fraud profile is a set of information regarding the likelihood of fraud or genuineness based upon the categories discussed herein. The user fraud profile may be associated with a user account (discussed below). UTILIZING EMBODIMENTS OF THE INVENTION

Embodiments of the invention can be utilized by any of several types of entities. Embodiments of the invention may be used by a tax professional, a taxpayer using a self-preparation tax return product, a financial professional, a government taxing authority prior to processing of the tax return, or a third party acting on behalf of either or both of the tax professional or the taxpayer. As utilized by the various entities, the invention may serve various purposes. First, the invention may be a background operation that monitors the input of information as the user is entering it. Second, the invention may be a gatekeeper that analyzes the completed tax return before allowing the tax return to be submitted to the taxing authority. Third, the invention may be a triage function that examines tax returns that are designated as potentially fraudulent by an outside person or function. For example, an agent of the taxing authority notes potential indications of fraud in a tax return under review and submits the return for further analysis by the system. Fourth, the invention may be a surveyor function that tests certain tax returns at random or designated intervals.

In embodiments of the invention, a self-preparation tax return product utilizes the invention. For example, if the taxpayer uses a self-preparation tax return product, such as tax preparation software, embodiments of the invention provide a service to the taxpayer in conjunction with using the tax preparation software. The service may be provided to the user as a value-added benefit to the tax preparation software or as a pay service. Alternatively, if embodiments of the invention are used by the tax professional, the tax professional may use the service in conjunction with preparation and filing of the tax return. Upon completion and analysis of the subject tax return, the tax preparation program may submit the subject tax return for filing along with information indicative of the taxpayer identity confidence score. For a high score, this information reassures the taxing authority that the subject tax return is genuine.

In embodiments of the invention, the invention is utilized by a tax professional. The tax professional includes any entity, either a legal person or natural person, or a computer program adapted to preparing taxes or providing other financial services. Examples of tax professionals include, but are not limited to, the following: a company, such as H&R Block, Inc.®, or an employee or agent of such a company; software adapted to prepare tax returns or other financial documents; and a person, legal or natural, who advises or assists the taxpayer in preparing their own tax return. The tax professional may also comprise a database for storing at least a portion of the set of taxpayer information. It should also be noted that in rare instances, the tax professional may be a malfeasant. To please clients, some tax professionals claim prepare tax returns claiming additional deductions and credits for which the subject taxpayer does not qualify. Some tax professionals also steal the identities of their clients to prepare future fraudulent tax returns based upon these identities. Embodiments of the invention detect fraud by malfeasant tax professionals.

In other embodiments of the invention, the invention is utilized by a financial professional. A financial professional includes any entity, either a legal person or a natural person, or a computer program adapted to provide financial services or products. For example, the financial professional could be a financial advisor, accountant, attorney, etc. By way of another example, the financial professional could be a website for monitoring the taxpayer's financial assets and liabilities. The financial professional does not actually prepare, or assist in preparing, the tax return. Instead, the financial professional has access to a completed and/or filed tax return that was prepared by the taxpayer or the tax professional. Embodiments utilized by the financial professional may be a free or pay service provided by the financial professional to clients to help bolster the legitimacy of the clients' tax returns. The financial professional may do so because the financial professional has access to additional authentication information for the taxpayer, in excess of the authentication information available to the tax professional.

In embodiments of the invention, the tax professional and financial professional are the same entity, or are employees of the same entity, or are otherwise associated with each other through, for example, a contractual or business relationship. In some embodiments, there is no financial professional involved. In other embodiments, there is no tax professional involved, such as in an instance where the taxpayer prepares their own tax return. As such, the term “tax professional” or “financial professional” is used throughout to denote either or both the tax professional and financial professional. The financial professional may also act on behalf of either the taxpayer or the tax professional in the discussed steps.

In still other embodiments of the invention, the invention is utilized by a taxing authority. The taxing authority (also known as a revenue service, revenue agency, or taxation authority) is a government entity or an entity associated with a government body. The taxing authority has, through prescribed legal authority, the power to assess, levy, and collect taxes. The taxing authority may also have the power to collect other non-tax-related revenue, such as penalties and interest. The taxing authority may perform secondary functions, such as investigating and charging tax fraud, performing audits, etc. The taxing authority can be at any level of government: international, federal, state, county, and city. Examples of taxing authorities include the IRS, the Missouri Department of Revenue, etc. The taxing authority may be motivated to utilize the invention to provide a safe method of electronic filing for the taxpayers, thereby encouraging electronic filing which is easier and cheaper to receive than paper tax returns. Further, the invention may be useful to a taxing authority to take a survey of incoming tax returns to determine how common fraudulent returns are. As an example, if the invention notes an increase in potentially fraudulent returns being received, the taxing authority may raise the minimum acceptable taxpayer identity confidence score for future tax returns.

In one embodiment, the taxpayer enters information from his tax-related documents, such as W2s and 1099s, into the self-preparation tax return program. In another embodiment, the taxpayer provides the tax-related documents to the tax professional, who enters the information into a professional-preparation tax return program. The self-preparation tax return program and the professional-preparation tax return program may be the same as or interface with the computer program of embodiments of the invention. The tax return program generates a tax return.

The tax return is essentially a report filed with the appropriate government taxing authority, such as the IRS in the case of U.S. federal income tax. Typically, the tax return contains information used to calculate the tax due. Typically, the tax return is either printed or hand-written on a form generated by the taxing authority, such as the Form 1040. However, the tax return could be on another type of form, a financial document, or other document. On the tax return, the taxpayer or tax professional calculates the taxes due. To assist in the calculation and to allow the taxing authority to verify the calculations, the tax return contains pertinent information associated with the taxpayer for the tax period. The tax return can be either written, digital, or a combination of both. In other embodiments, information relevant to the taxpayer and the tax to be paid are provided on other various forms and documents.

The “subject tax return,” as used herein, refers to the tax return that is being subjected to the authentication by the invention. The subject tax return purports to relate to the taxes paid and owed by the subject taxpayer. The subject tax return includes information for the subject taxpayer, including identification information, contact information, and other tax information. As discussed above, the subject tax return may be designated for authentication as a free service or as an additional service by the tax professional, financial professional, and/or taxing authority. The subject tax return may refer to a set of information indicative of a tax return in lieu of a completed tax return itself. In embodiments of the invention, the system extracts key tax information from the subject tax return that aids in the detection of fraud. For example, the system may extract taxpayer identification information, deposit account information, employer information, etc., while not extracting the dollar amounts involved in the calculation of the tax due. In other embodiments, the complete and entire subject tax return is imported to the system for analysis, after which the system only analyzes the pertinent information.

Tax information associated with any tax return includes one or more of the following: name of taxpayer; name of taxpayer's spouse, if any; address; social security number; bank account information; wages; retirement investments; insurance distributions; income tax withholdings for the tax period; capital gains and losses; dependents, including number of dependents, names, and identifying information; tax deductible expenses, such as charitable contributions; and like information. The tax information may also be received from various sources, including a prior-year tax return filed by the taxpayer; entry of tax information by the taxpayer into a data store, such as via tax preparation software; and entry of tax information by a tax professional. For example, if the taxpayer uses self-preparation tax software, embodiments of the invention may generate or otherwise populate the database using tax information entered by the taxpayer via the self-preparation tax software. In alternative embodiments, the tax information may not necessarily be tax information associated with a tax return for the taxpayer but instead may be information associated with the taxpayer. For example, tax information may include a credit score (or credit score range) of the taxpayer or a name of credit accounts held by the taxpayer.

Tax returns are typically due in a tax return filing season following the tax year. A tax year is typically a calendar or fiscal year upon which the tax is calculated. A tax period may be another length of upon which the tax is calculated, such as a month, a quarter, half of a year, two years, five years, etc. It should be appreciated that the “current tax year” and “current tax period” as used herein, refers to the tax year or tax period for which the subject tax return relates. For example, a tax return submitted in March 2016 typically relates to the 2015 tax year. This is because the taxes accrue ending December 31 of the tax year and the tax return is submitted at some point in the following calendar year as prescribed by law (e.g., by April 15^{th}). “Previous tax returns” can include previously filed tax returns for the current tax year and/or current tax period. To follow the above example, for a tax return submitted in March 2015, previous tax returns include tax returns submitted in January 2015 through March 2015 (up to immediately preceding the submission of said tax return). “Previous tax year” and “previous tax period,” as used herein, refer to those tax years and tax periods for which tax returns are no longer being typically submitted. To follow the above example, for a tax return submitted in March 2015, previous tax years would include the 2013 tax year, the 2012 tax year, etc.

### Calculating the Taxpayer Identity Confidence Score

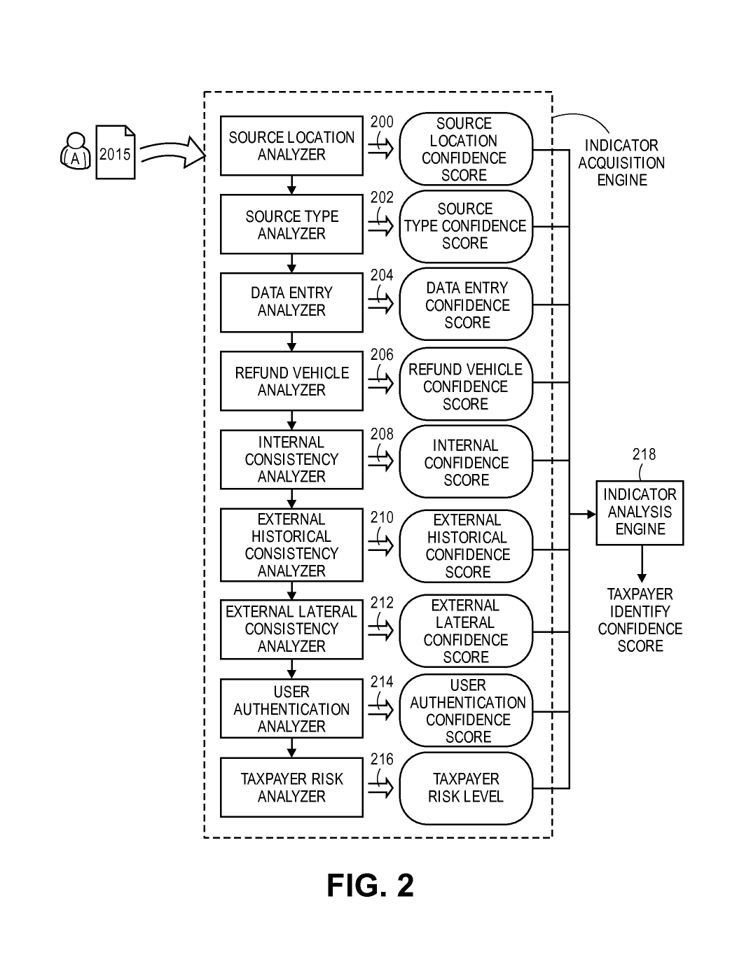

Returning to the figures, FIG. 2 illustrates an alternative embodiment to that which was illustrated in FIG. 1. Generally, in the embodiment as illustrated in FIG. 2 the indicator acquisition engine generates a confidence score that corresponds to each of the indicator acquisition analyzers. The indicator acquisition engine of this embodiment performs a preliminary analysis within each analyzer to provide a corresponding confidence score for that analyzer.

More specifically, in Step 200 the source location analyzer produces a source location confidence score based upon the confidence indicators detected in Step 102. In Step 202, the source type analyzer produces a source type confidence score based upon the confidence indicators detected in Step 104. In Step 204, the data entry analyzer produces a data entry confidence score based upon the confidence indicators detected in Step 106. In Step 206, the refund vehicle analyzer produces a refund vehicle confidence score based upon the confidence indicators detected in Step 108. In Step 208, the internal consistency analyzer produces an internal confidence score based upon the confidence indicators detected in Step 110. In Step 210, the external historical consistency analyzer produces an external historical confidence score based upon the confidence indicators determined in Step 112. In Step 212, the external lateral consistency analyzer produces an external lateral confidence score based upon the confidence indicators determined in Step 114. In Step 214, the user authentication analyzer produces a user authentication confidence score based upon the confidence indicators determined in Step 116. In Step 216, the taxpayer risk analyzer produces a taxpayer risk level based upon the confidence indicators determined in Step 118. It should be appreciated that (as with any discussion of method steps discussed herein) any or all of the steps may be performed simultaneously, in any sequence, or not at all.

In Step 218, the indicator analysis engine compares these various confidence scores together to determine the taxpayer identity confidence score. The indicator analysis engine may also analyze the underlying data behind the various confidence scores. In calculating the taxpayer identity confidence score, the indicator analysis engine may weight different confidence scores (and the information upon which they are calculated) based upon importance and reliability. For example, the user authentication confidence score may be more heavily weighted than the source type confidence score, because the user's ability to authenticate himself may be more important than the type of source computing device through which the user accesses the system.

The indicator analysis engine may also heavily weight confidence scores of a great magnitude. For example, the user authentication analyzer produces a +100 value for the user authentication confidence score, meaning the user has aced each of the litany of possible authentication methods (discussed below). The indicator analysis engine may calculate a taxpayer identity confidence score that is very high (e.g., greater than +90), even if other confidence scores are not as high. As another example, the source location produces a −100 value for the source location confidence score, meaning that the source information for the user's computing device gives every indication of being fraudulent (e.g., a hardware address and IP address of a known malfeasant, routing through a server dedicated to tax fraud, from a geographic location outside the country or from a geographic location that is a known ‘hotbed’ for tax fraud). The indicator analysis engine may calculate a taxpayer identity confidence score that is very low (e.g., lower than −90), despite the ability of the user to receive relatively high confidence scores for the other categories. This is because a sophisticated malfeasant may have thoroughly stolen the subject taxpayer's identity so as to receive relatively high confidence scores throughout, but the strong indication of fraud via the source location analyzer trumps.

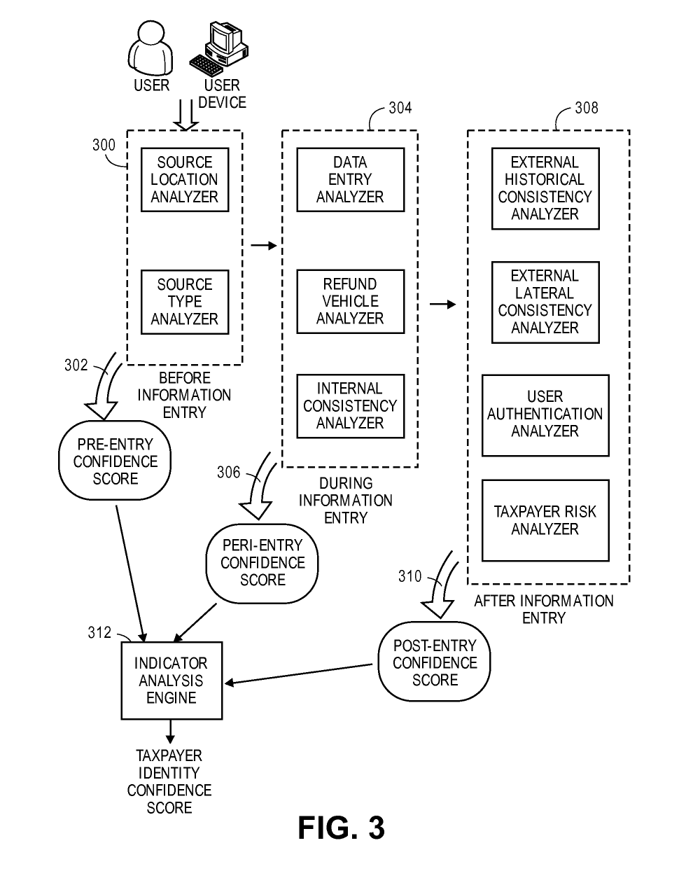

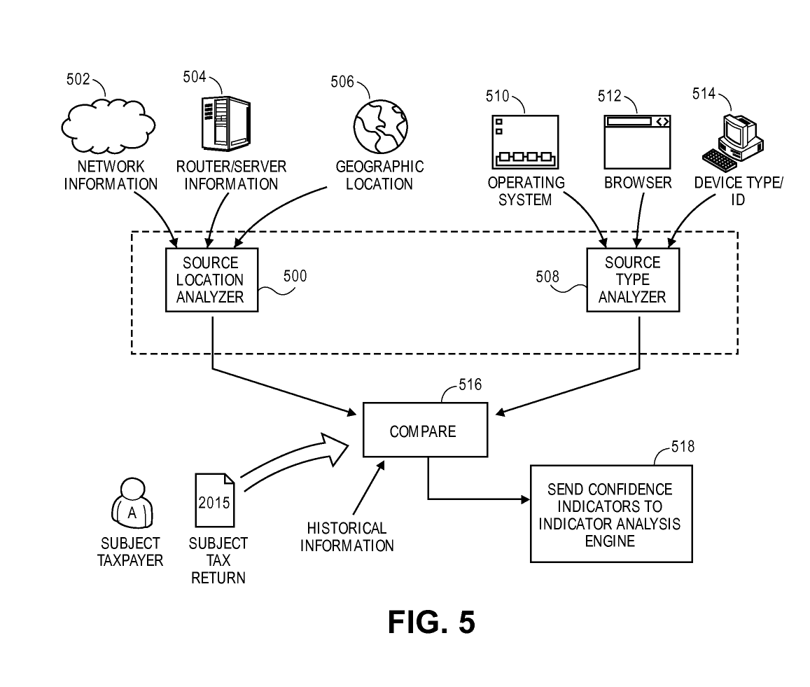

FIG. 3 illustrates yet another embodiment of the invention in which the system calculates various confidence scores based upon timing. In Step 300, the source location analyzer and the source type analyzer evaluate the user and the user device as the user and the user device connect to the system (and/or the tax return program). In this step, the source location analyzer and the source type analyzer gather the available information before the input of any data into the system. This data could include the data sources discussed in FIG. 5 below (e.g., network information, router/server information, geographic location, operating system, browser, device type, device ID, etc.), a username and password utilized by the user, the time of day, the date during the tax return filing season, a taxpayer account associated with the user, etc. It should be noted that Step 300 may operate each time a user connects to the system. For example, if the user connects to the system from a first location via a first device, and then at a later time connects from a second location via a second device, this may be a confidence indicator.

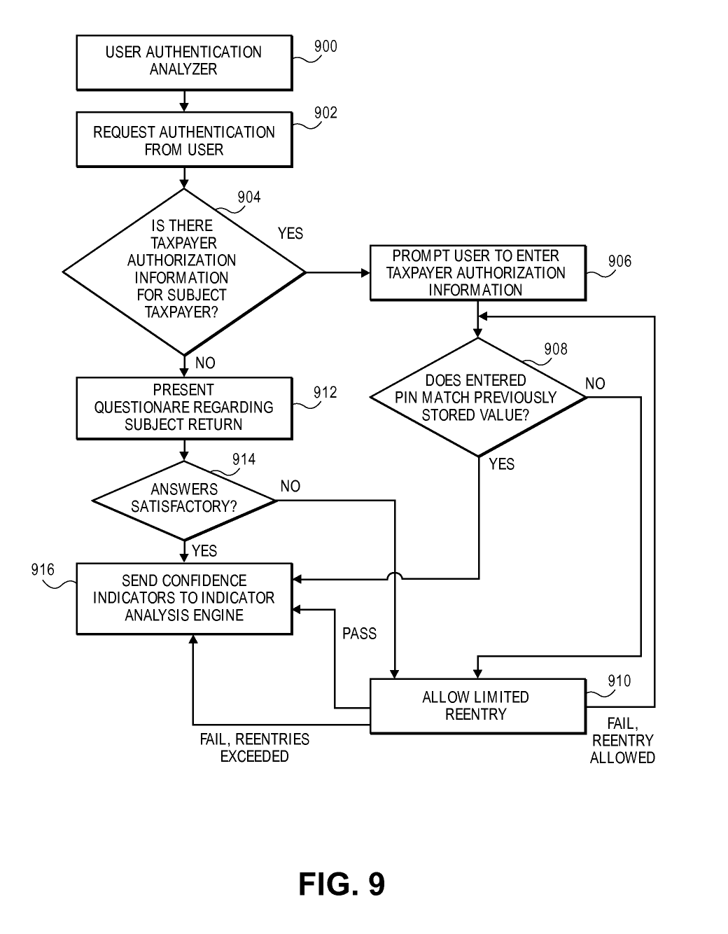

Based upon this information, in Step 302 the system calculates a pre-entry confidence score. In some embodiments, the pre-entry confidence score must be above a certain threshold before allowing the user to continue. If the pre-entry confidence score is below the threshold, the system may prompt the user to authenticate (as shown in FIG. 9 and discussed below) or block the user from further accessing the system.

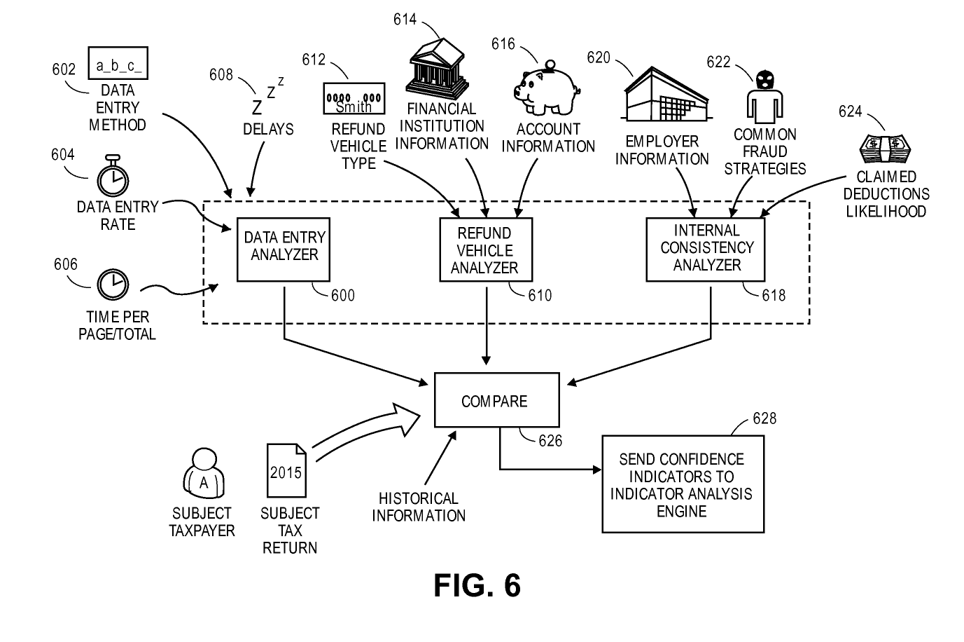

In Step 304, the data entry analyzer, refund vehicle analyzer, and internal consistency analyzer evaluate the entry of information by the user during the entry by the user to determine confidence indicators. This information could include the information sources discussed in FIG. 6 below (e.g., data entry method, data entry rate, time per page, total time, delays, account information, bank information, refund vehicle type, employment information, common fraud strategies, claimed deductions likelihood, etc.) In some embodiments, the indicator acquisition analyzers may be operating as a background function to monitor and evaluate the entry of information (and the information input) while it is happening in real time. In other embodiments, the indicator acquisition analyzers evaluate historical information about the input of information. For example, the system and the tax return program may be separate and distinct, the tax return program keeping a record of information related to the input of information but not evaluating this information. The record of information is later submitted to and evaluated by the system.

In Step 306, the system calculates a peri-entry confidence score, i.e., a confidence score based on entries or other information during preparation of the tax return. In some embodiments, the peri-entry confidence score is continually or periodically updated during the data entry process. In some embodiments, if the peri-entry confidence score drops below a certain threshold during information entry, the system may require the user to further authenticate to continue entering information. In other embodiments, the peri-entry confidence score is a stagnant value encompassing an evaluation of all information gathered during information entry.

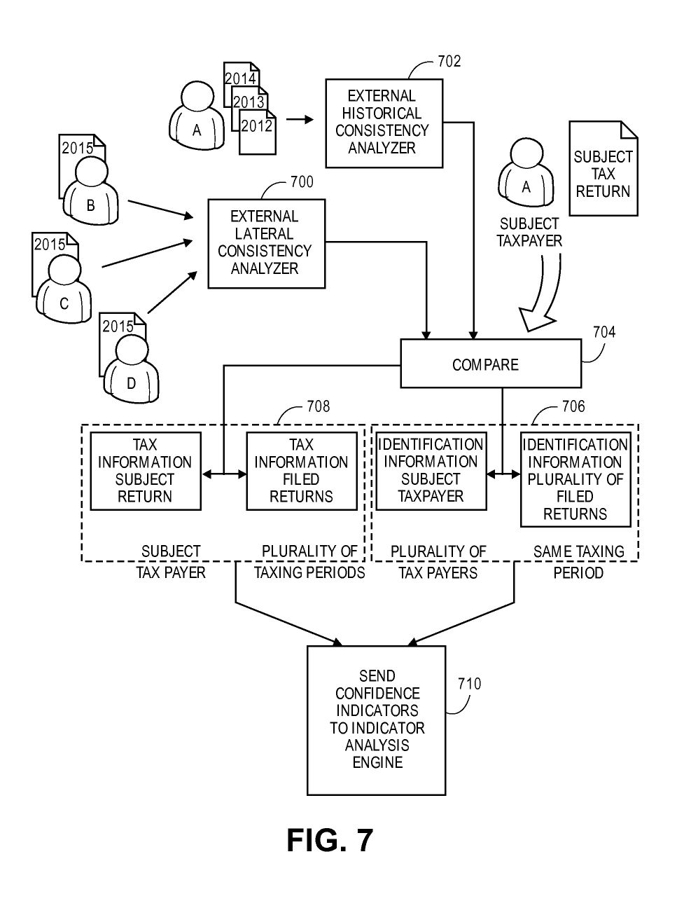

In Step 308, the external historical consistency analyzer, the external lateral consistency analyzer, the user authentication analyzer, and the taxpayer risk analyzer evaluate information after and/or unrelated to the entry of information to determine confidence indicators. The information could include the information sources discussed in FIGS. 7-10 below (e.g., tax returns for a plurality of taxpayers in the current tax year, tax returns for the subject tax payer for prior tax years, user authentication information, a repository of high risk data, etc.). Some information, such as that acquired by the taxpayer risk analyzer, may be determined independently from the completion of the subject tax return. However, before and during entry, the system may have too little information about the subject taxpayer to determine a taxpayer risk level.

In Step 310, the system calculates a post-entry confidence score. The post-entry confidence score is a measure of the likelihood of genuineness based upon the complete tax return and external verifications. In some embodiments, there is a minimum acceptable post-entry confidence score to allow the subject tax return to be filed, meaning that even if the pre-entry confidence score and the peri-entry confidence score are relatively high, the user must meet the threshold on post-entry confidence score. This is a safeguard to ensure that even upon a malfeasant thoroughly imitating the subject taxpayer, the subject tax return will be denied entry based, for example, upon a duplicate SSN.

It should be appreciated that in some embodiments of the invention, the pre-entry confidence score, the peri-entry confidence score, and the post-entry confidence score are based upon information generated by indicator acquisition analyzers not depicted in their respective boxes in FIG. 3. For example, the pre-entry confidence score may be based in part upon preliminary user authentication information to the user authentication analyzer. As another example, the source location analyzer and the source type analyzer may continue to monitor the source during and after the information entry. An unusual change in information may indicate fraud (e.g., a user accesses the system and enters most information from a geographic location near their residence, but then accesses the system to change refund vehicle information and file the return from a foreign country, indicating a malfeasant has hacked into the user's account and is attempting to file a fraudulent return). As yet another example, the data entry analyzer may continue to monitor the entry of information during the submission of the subject tax return to the taxing authority by the user to ensure that the user continues to exhibit the same characteristics. The depicted indicator acquisition analyzers in FIG. 3 (like the other figures) are therefore exemplary of one embodiment of the invention.

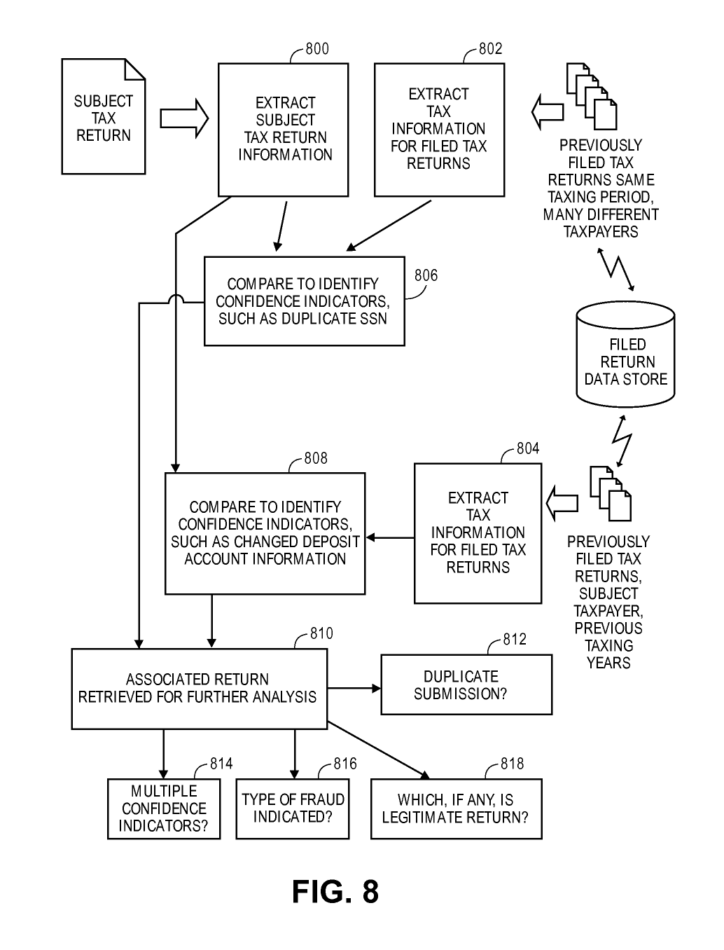

In Step 312, the indicator analysis engine calculates the taxpayer identity confidence score based upon the pre-entry confidence score, the peri-entry confidence score, and/or the post-entry confidence score. It should be appreciated that in some embodiments of the invention, the taxpayer identity confidence score is entirely or substantially all of the post-entry confidence score (as discussed below in FIG. 8). In these embodiments, the system may receive the subject tax return without any information as to the information entry or the source. For example, a taxing authority may receive the subject tax return via an intermediary tax professional, such that the taxing authority has no verifiable information except that which appears on the subject tax return itself (and in associated metadata).

### Utilizing the Taxpayer Identity Confidence Score

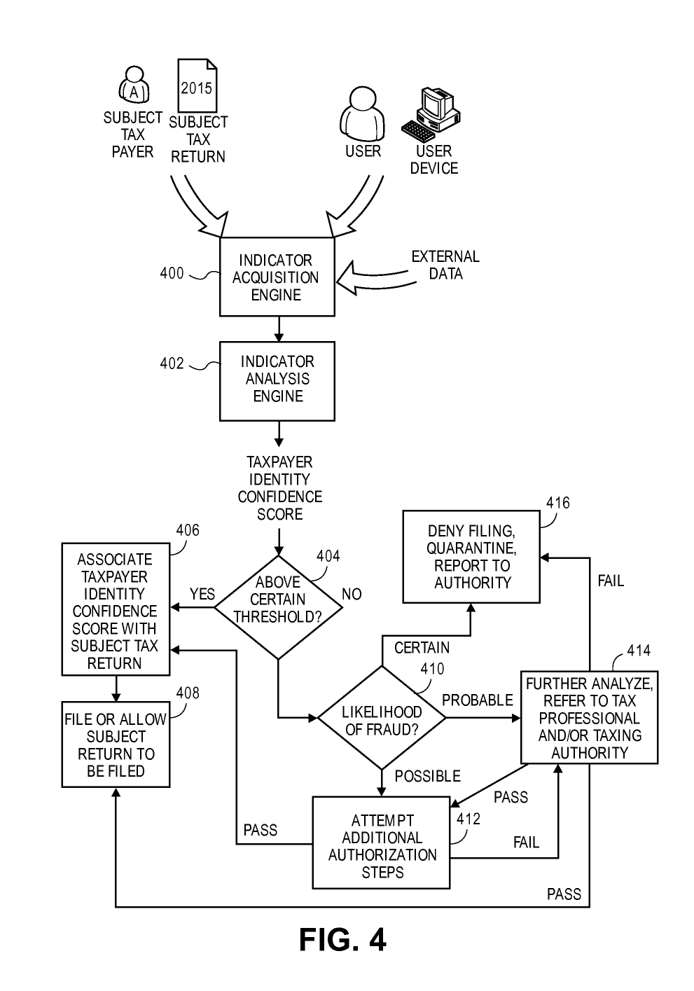

FIG. 4 is generally directed to the utilization of the taxpayer identity confidence score once it is calculated via one of the above (or similar) methods. As discussed above, in Step 400 the indicator acquisition engine detects confidence indicators related to the subject tax return and/or the user. As illustrated in FIGS. 2 and 3, the indicator acquisition engine and/or the indicator analysis engine may calculate intermediate confidence scores. In Step 402 the indicator analysis engine calculates the taxpayer identity confidence score. In some embodiments of the invention, the taxpayer identity confidence score is displayed on a graphical user interface to the user. In other embodiments, the taxpayer identity confidence score is only displayed to the user if it is above or below a certain threshold.

In some embodiments, the taxpayer identity confidence score varies throughout the tax return preparation and submission process. Accordingly, the indicator acquisition engine may continue to determine confidence indicators after a taxpayer identity confidence score is calculated. The indicator analysis engine may also continue to determine the taxpayer identity confidence score based on new and changing confidence indicators determined by the indicator acquisition engine. The indicator analysis engine may also more heavily weigh recently determined confidence indicators, and/or more heavily weigh changing confidence indicators. In other embodiments, the taxpayer identity confidence score is a static value calculated before the submission of the tax return.

In Step 404, the system determines whether the taxpayer identity confidence score is above a certain high threshold. This high threshold is, in essence, a “proven to be genuine” threshold in which the system is sufficiently confident that the subject tax return is genuine so as to allow the taxpayer to file the tax return with no further analysis or authentication. In some embodiments, the user is invited to attempt to increase their taxpayer identity confidence score, such as discussed below, even though their taxpayer identity confidence score is already above the high threshold. The user may be incentivized to further authenticate to insulate the subject tax return from future scrutiny (such as when a later-filed tax return bears a duplicate SSN), to provide the taxing authority with additional confidence in the genuineness of the subject tax return, etc.

If the taxpayer identity confidence scores is above the high threshold, in Step 406 the system associates the taxpayer identity confidence score with the subject tax return. In some embodiments, the system places the taxpayer identity confidence score onto the subject tax return or otherwise associates the score with the subject tax return. For example, the subject tax return may have a field for the taxpayer identity confidence score or the taxpayer identity confidence score may be disposed on the top or margin area of the subject tax return. In other embodiments, the taxpayer identity confidence score is included in an electronic communication to the taxing authority that accompanies, precedes, or follows the submission of the subject tax return to the taxing authority. In another embodiment, score not associated, but only filed if it meets the high threshold

In some embodiments, the taxpayer identity confidence score is associated with metadata of the subject tax return. Metadata associates one set of data with another set of data. The metadata may be embedded in the subject tax return, stored externally in a separate file that is associated with the subject tax return, otherwise associated with the subject tax return, or all of the above. Embedding the taxpayer identity confidence score into the same file with the subject tax return can be advantageous because it allows the metadata to travel as part of the data it describes. In some such embodiments, metadata is associated with a section or field of the subject tax return. This is advantageous where, for example, the same subject tax return contains more than one taxpayer identity confidence score (e.g., a joint taxpayer), or where there are confidence scores associated with various sections or attached documents to the subject tax return. In other such embodiments, the metadata is associated with the subject tax return file as a whole. Externally stored metadata may also have advantages, such as ease of searching and indexing. The metadata may also be stored in a human-readable format, such that an operator can access and understand the metadata without any special software. The metadata may also be encrypted and locked such that a malfeasant cannot change the taxpayer identity confidence score associated with the subject tax return before submitting the subject tax return to the taxing authority.

In Step 408, the system files, allows another program or process to file, or accepts the subject tax return. In systems that perform a gatekeeping function (as discussed above), the system in essence opens the gate to allow the user to file the subject tax return. In systems that perform a triage function (as discussed above), the system in essence exonerates the subject tax return. In systems that perform a surveyor function (as discussed above), the system in essence records the findings and moves on to another tax return.

If the taxpayer identity confidence score is below the high threshold discussed above in Step 404, the system further analyzes a likelihood of fraud in Step 410. In determining this, the system may utilize additional thresholds. For example, a taxpayer identity confidence score below a certain low threshold is “certain” to be fraudulent, between the low threshold and an intermediate threshold is “probable” to be fraudulent, and above the intermediate threshold but below the high threshold is “possible” to be fraudulent.

If the system determines that the likelihood of fraud is only possible (i.e., the taxpayer identity confidence score is between the intermediate threshold and the high threshold), in Step 412 the system may allow the user to attempt additional authentication steps to verify their genuineness. While discussed more below, these additional authentication steps could include the entry of additional authentication information, biometric or facial recognition software, the entry of credentials to other verifiable computer systems, the answering of “out of wallet” questions, response to certain known contact information for the subject taxpayer, etc. If the user passes the additional authentication steps so as to raise the taxpayer identity confidence score above the high threshold, the system then proceeds to Step 406 (discussed above) and associates the new taxpayer identity confidence score with the subject tax return. If the user fails the additional authentication steps, the taxpayer identity confidence score may be correspondingly lowered.

If the system determines the likelihood of fraud to be probable (i.e., the taxpayer identity confidence score is below the intermediate threshold but above the low threshold), in Step 414 the system performs further analysis and/or refers the subject tax return for further analysis. In embodiments, the further analysis may include requesting additional information from the user to verify the user's identity. In some embodiments, this further analysis may be performed by an operator (i.e., a human that is an agent of or associated with the system). The operator may be alerted to the probable fraud status and assigned to investigate. The operator may then attempt secondary authentication methods to verify the user (e.g., calling a phone number of the subject taxpayer in an attempt to speak with the subject taxpayer to verify that the subject taxpayer is or has authorized the user). The operator may also review the collected information to determine a course of action (e.g., perform further investigations into certain criteria, instruct the system to continue to monitor the user, etc.) The operator may also request that the user physically travel to a location associated with system or the tax professional, such as an office location of the tax professional, for in-person verification. If the user authenticates successfully, the system may proceed to Step 406 above. If the user fails to authenticate, the system may downgrade the taxpayer identity confidence score to “certain” fraud.

If the system determines the likelihood of fraud to be certain (i.e., the taxpayer identity confidence score is below the low threshold), in Step 414 the system acts to prevent the fraud. Steps involved in preventing fraud could include denying filing, rejecting the filed return, quarantining the subject tax return such that the user can no longer alter or delete it, reporting the fraud to the taxing authority, reporting the fraud to the tax professional, reporting the fraud to the subject taxpayer via known contact information, etc.

In Step 416, the system, or an operator of the system, notifies an appropriate law enforcement agency and/or the taxing authority about the potential or probable fraud. In many instances, timely notification makes it is easier to discover and prosecute the malfeasant. For example, a malfeasant may submit the subject tax return to the system. The system detects the fraud and notifies a fraud prevention department of the taxing authority. Because the malfeasant is still connected to the system, waiting for the subject tax return to be filed, the fraud prevention department may be able to track the malfeasant's location based upon information obtained from the computer through which the malfeasant is connected to the Internet. By acting quickly, the system enables the arrest and prosecution of more malfeasants. Fraud therefore becomes less likely due to the increased likelihood of failure and prosecution.

### Determining Confidence Indicators

The various steps performed by the system, and by the other embodiments of the invention, will now be discussed in detail. The system, the computer program, and the computerized method determine confidence indicators via the steps described herein and their substantial equivalents. The system, computer program, and computerized method then determine the taxpayer identity confidence score based upon the confidence indicators. It should be appreciated that the steps described herein can be performed in any order, simultaneously, or not at all.

### Analysis Before Information Entry

Turning to the figures, FIG. 5 depicts exemplary methods in which the system detects confidence indicators as, during, or while the user connects to the system and/or a tax return program. In some embodiments this analysis is performed, at least in part, prior to the entry of information by the user.

In Step 500, the source location analyzer collects information related to the location and other network information related to the source computing device and the user. This information is relevant to determining how likely the user is in fact the subject taxpayer or someone authorized by the subject taxpayer. In Step 502, the source location analyzer retrieves network information. The network information is related to the computer network or networks to which the user device is connected and/or passes through before arriving at the system. Certain networks may be favored by malfeasants. Similarly, routing information through multiple hubs may also be indicative of fraud because the malfeasant is trying to hide his location and identity (as discussed below). Also, the malfeasant may utilize a mobile broadband network to mask an exact geographic location, while a legitimate taxpayer is more likely to utilize a DSL- or cable-based broadband connection. In Step 504, the source location analyzer retrieves router and server information associated with the computer networks. These specific routers and servers provide information about the type of user that is accessing them.

In Step 506, the source location analyzer retrieves and/or calculates geographic location information for the user and the user device. The geographic location information provides information as to the likelihood of genuineness or fraud. If the geographic location is near or in the geographic location for the subject taxpayer that is previously stored and/or verifiable, then it is likely that user is in fact the subject taxpayer. If the geographic location is outside the United States, then it is more likely that the user is a malfeasant (unless the subject taxpayer's address and/or employer address is in a foreign country). In the United States, taxpayers are permitted to file a tax return from outside the United States, but less than 2% of tax returns are filed from outside the United States. If no known address or employer is outside the United States, the odds that the subject taxpayer is traveling out of the country and has decided to prepare their tax return in another country is very low. Similarly, certain geographic locations outside the United States are known ‘hotbeds’ for U.S. tax fraud. These geographic locations have a much higher than usual propensity for being the source location for tax fraud within the United States.

In Step 508, the source type analyzer collects information related to the source type that is accessing the system and/or the tax return program. This information is relevant to the likelihood that the user is genuine or fraudulent. In many instances, the source type is not as important in the analysis as the consistency of the source type over time.

In Step 510, the source type analyzer retrieves information regarding an operating system used by the user device, such as WINDOWS™, iOS™, LINUX™ ANDROID™, etc. The source type analyzer may also retrieve information regarding a version number of the operating system, other programs installed on the source device, etc. Certain operating systems, and certain versions thereof, may be indicative that a malfeasant is utilizing the source device due to known security shortcomings of that operating system and/or version.

In Step 512, the source type analyzer retrieves information regarding an Internet browser being used to access the system and/or the tax return program, such as INTERNET EXPLORER™, FIREFOX™, CHROME™, SAFARI™, etc. As with operating systems, certain browsers may be preferred by malfeasants. Some browsers, such as TOR BROWSER™, are designed to mask the source location by rerouting information through a series of relays. These browsers may also be preferred by malfeasants attempting to block their source location and type. In Step 514, the source type analyzer retrieves information related to the user device itself. The information may include the device type (e.g., desktop computer, laptop computer, tablet computer, smart phone, etc.). The information may also include a device identification number (“device ID”), such as a MAC address associated with a Network Interface Card or other physical address (also known as a Burned-In Address) associated with the source device. This information is used by the system to identify the specific user device that is accessing the system.

In Step 516, the system compares the information retrieved in the above-mentioned steps with information regarding the subject taxpayer, the subject tax return, and historical information. The historical information may be related to any or all of the above-discussed categories. For example, the system may compare the device ID of the user device to a previously stored device ID or device IDs previously utilized by the subject taxpayer in submitting previous tax returns. If the current device ID matches one of the previously stored device IDs, the system assigns a positive confidence indicator. As another example, the system may compare the geographic location of the user device with the various geographic locations recited on the subject tax return. If the user device is within a certain threshold distance of one of the locations on the subject tax return, the system assigns a positive confidence indicator. If the system can confirm that the user device is precisely located at one of the addresses on the subject tax return, the system may assign a very high positive confidence indicator.

As yet another example, if the operating system and browser of the user device change multiple times during the preparation and submission of the subject tax return, the system may assign a negative confidence indicator, as this is unusual activity for a taxpayer. Similarly, if the user utilizes a plurality of different user devices during the preparation of the subject tax return (e.g., more than three), the system may assign a negative confidence indicator.

While performing Step 516, the system may generate confidence indicators not base upon a comparison to the other factors. For example, the source device having a device ID that belongs to a known malfeasant may be a very negative confidence indicator without comparing the information to the subject tax return or historical information. Similarly, the use of a deceptive browser may be a confidence indicator even if the subject taxpayer utilized such a browser in the past.

In some embodiments of Step 518, the indicator acquisition engine sends the confidence indicators (and in some cases the underlying information) to the indicator analysis engine for further analysis and comparison (as discussed above). In other embodiments of Step 518, the source location analyzer calculates a source location confidence score as discussed in Step 200, and the source type analyzer calculates a source type confidence score as discussed above in Step 202. The respective indicator acquisition analyzers send their respective confidence scores to the indicator analysis engine in addition to (or in lieu of) the confidence indicators and underlying information. In still other embodiments, the indicator acquisition engine additionally calculates a pre-entry confidence score as discussed above and sends the pre-entry confidence score to the indicator analysis engine along with (or in lieu of) the confidence indicators, the underlying information, the source location confidence score, and/or the source type confidence score.

### Analysis During Information Entry

FIG. 6 depicts exemplary methods in which the system determines confidence indicators as, during, or while the user inputs information into the system and/or the tax return program. In some embodiments, these analyses are performed during the input of information. In other embodiments, these analyses are performed at a later time.

In Step 600, the data entry analyzer collects information related to the manner in which information is input into the system and/or tax return program. This information is relevant to determining whether the subject tax return is genuine or fraudulent in numerous ways. First, users preparing their taxes will usually be relatively slow and deliberate in entering information, because completing taxes requires the location of and reference to other tax-related documents. Typical users will complete the tax return generally in a predictable manner. Serious deviations from these expectations can be indications of fraud, as discussed below.

In Step 602, the data entry analyzer collects information related to a data entry method utilized by the user. This information can include information as to whether data is manually typed in (and if so, whether on a software-based touch screen keyboard and/or a physical, external keyboard), copied and pasted in from an external source, completed prior to upload to the system, completed via a speech-to-text computer program, automatically completed by some computerized function, etc. Manually typed information is expected for most users. Copied and pasted text may be expected for discrete entries, such as those that would be accessed via another website such as an employer's administrative website, but not for large strings of text. Other relevant information could include information that was deleted and reentered or changed by the user. For example, if the user uploads a completed tax return and then changes the bank account information before submitting the subject tax return, this could be indicative of fraud.

In Step 604, the data entry analyzer collects information related to a data entry rate or rates for the user. As discussed briefly above, variable data entry rates are expected for most users, especially those utilizing self-preparation tax return programs. Typically, the user immediately knows some information (such as name and address) whereas other information will require the taxpayer to locate and read a document (such as W2 and 1099 information). A steady data entry rate is indicative of the user either copying the information from an illegally obtained tax return, or fabricating information to put on the subject tax return. Exceptions to this general principle do exist, such as for tax professionals who are more knowledgeable about the tax return preparation process and generally retrieve and review all relevant documentation before beginning the tax return preparation process. In some embodiments, the data entry analyzer looks for patterns in the irregularity of entry, such that the entry is not truly random. For example, if there are unnatural patterns in the data entry rate, such as delays of whole seconds instead of portions of seconds, this may be indicative that a computer script is entering the information.

In Step 606, the data entry analyzer collects information related to the time that each page is viewed, the total preparation time, etc. Similarly to data entry rate, the amount of time that the user views a page may be indicative of a malfeasant being the user. For example certain pages of the tax return preparation program include fields requesting information that the user (if the subject taxpayer or someone so authorized) would instantly know. This includes taxpayer name, taxpayer SSN, taxpayer address, number of dependents, contact information, etc. Typically, a user will spend little time on these pages because the user already knows all the information to complete the fields on that page. Other pages of the tax return preparation program include fields requesting information that the user would likely not instantly know, such as an employer identification number (EIN) or dollar amounts for earnings. Similarly some pages of the tax return preparation program include large amounts of written information that a typical user will read before proceeding. While the amount of time the user spends on any certain page is, of course, not dispositive of genuineness or fraud, it may be indicative of fraud. For example, if the user stays on pages in an inverse relationship to what is expected, the user may be having to research to find illegally obtained taxpayer identities and then entering tax information from a standard fraudulent tax return. Similarly, if the user completes the entire tax return in an amount of time under a certain threshold (e.g., half of an hour), the total preparation time may be indicative of fraud. However, the total preparation time is dependent on the complexity of the subject tax return that is completed, as some tax returns are quick and easy to prepare while others require many hours. Thus, Step 606 may include comparing the time to complete the tax return against a pre-set standard based upon an assigned difficulty level for completing the tax return.

In Step 608, the data entry analyzer retrieves information related to delays in the tax preparation process. A typical taxpayer will experience delays in preparing their tax return. For example, a user may complete the tax return and then delay filing for review by the user and/or a spouse. As another example, a typical user may also experience delays based upon research into understanding complex tax concepts. Despite any attempt at simplification, tax laws and regulations are complicated and change every year. The typical user (i.e., one not intimately familiar with the current tax laws, and one not having a simple tax return to complete) will spend a certain amount of time during tax preparation reviewing information on the display, asking questions of tax professionals, doing external research, etc. If the user experiences no delays during the tax return preparation process, especially when compared to using self-preparation tax software and/or a complex tax return, this may be indicative that the user is a malfeasant. Similarly, if the user never selects a ‘help’ link, never accesses more information, or never contacts a tax professional for help, these may be confidence indicators.

In Step 610, the refund vehicle analyzer collects information related to the refund vehicle that is selected by the user to receive a tax refund. The refund vehicle is the financial product or account that the user has selected to have the tax refund delivered to them by the taxing authority. Exemplary refund vehicles include direct deposit into a deposit account, a written check sent to the taxpayer, a written check sent to the taxpayer's bank, a prepaid card, a credit to a credit card company or other financial institution, etc. In some instances, the taxpayer will assign any interest in the tax refund to a tax preparer or a third party in consideration of a refund anticipation loan. In some instances, the tax professional or a third party may open a new account for the taxpayer specifically for receipt of the tax refund. The refund vehicle analyzer therefore evaluates the selected refund vehicle and associated information to determine whether a malfeasant is attempting to illegally obtain the tax refund.

It should be noted that virtually all fraudulent tax returns claim a tax refund. This is because without a tax refund, the malfeasant has no incentive to file the fraudulent return. While it is conceivable that a malfeasant may prepare a tax return with no tax refund in order to establish a historical record for future fraudulent tax returns (so as to fool the external historical consistency analyzer), this is highly unlikely. Another conceivable scenario is that the malfeasant may submit the tax return with a tax debt owed to escape scrutiny and then later file an amended tax return that changes information so as to receive a tax refund. However, the amended tax return would likely receive heightened scrutiny so as to make this scenario improbable. Therefore, tax returns that correspond with a tax debt owed instead of a tax refund may be assigned a very high positive taxpayer identity confidence score. It should also be noted that many malfeasants may claim a relatively low tax refund (e.g., $500) so as to escape increased or strict scrutiny by the taxing authority, or may claim an unusually large tax refund (e.g. $10,000) in an attempt to receive a high payoff. The amount of the tax refund may therefore be a confidence indicator.

In Step 612, the refund vehicle analyzer retrieves information related to a type of refund vehicle chosen by the user. Malfeasants prefer certain types of refund vehicles because they are untraceable, permanent, and anonymous. For example, a malfeasant may prefer to receive a tax refund on a prepaid card that is not associated with their name. The malfeasant can use the prepaid card without risking his identity. Similarly, the malfeasant may prefer to receive a tax refund via a written check. The malfeasant cashes the check (possibly using fraudulent identification bearing the name of the subject taxpayer) and then uses the cash anonymously. For these reasons, some taxing authorities do not allow or discourage certain refund vehicles in an attempt to mitigate fraud. Nonetheless, an attempt by the user to receive such a refund vehicle may be indicative of fraud. Similarly, if the refund vehicle is assigned to a third party, this may be indicative that the third party has verified the user is genuine or it may be indicative that the third party is a malfeasant.

In Step 614, the refund vehicle analyzer retrieves information related to a financial institution related to the refund vehicle. Most refund vehicles (especially those allowed or preferred by taxing authorities) are associated with a financial institution in some way. For example, if the refund vehicle is a direct deposit, the financial institution is the bank that maintains the account. The refund analyzer therefore retrieves information about the financial institution to detect fraud. If the financial institution is located in a foreign country, this may be evidence of fraud. Similarly, if the financial institution is a small regional bank in a region where the subject taxpayer does not live or work, this may be an indication of fraud. If, however, the financial institution is located or has a branch near the subject taxpayer, this may be an indication of genuineness. The type of financial institution may also be relevant. For example, a large bank is assumed to have more stringent authentication and oversight of accounts than a payday loan establishment. Other relevant information could be how long the financial institution has been in business, the demographic clientele of the financial institution (and whether the subject taxpayer is in that demographic), past instances of fraud associated with that financial institution, known past data breaches associated with the financial institution (such that account information may have been compromised), known authentication and verification procedures utilized by the financial institution with regards to customers, etc.

In Step 616, the refund vehicle analyzer retrieves information related to the account within the financial institution to which the refund vehicle will be designated. The relevant information may include the type of account (e.g., checking, savings, etc.), the name associated with the account (i.e., if it is the same as or substantially similar to the subject taxpayer), the length of time the account has existed, the current balance of the account, the average number of transactions per month, the manner in which the account was created (in person or over the Internet), the last time that the account owner was at the financial institution, unusual debits or credits in the account, any other deposits of tax refunds for current and previous tax years, the average amount of employer deposits (and whether they are consistent with the reported income levels), the name of employers direct depositing wages (and whether they are consistent with employers appearing on the subject tax return), the presence of debits and credits consistent with charitable donations and other tax-significant transactions (and whether they are consistent with tax deductions and credits claimed on the subject tax return), large transfers of funds between accounts (that may be consistent with money laundering), debits on the account that are likely associated with business or personal expenses (and whether these are consistent with claimed business expenses on the subject tax return), etc.

It should be noted that in some instances, financial institutions would not (or legally cannot) share this information with the system, unless the system is associated with a taxing authority and/or a reputable tax professional. In some embodiments, the user may enter electronic login information for the financial institution to gain authority to access at least a portion of the above-mentioned information. In some embodiments, the system accesses the above-mentioned information upon the users input of information indicative of the financial institution and/or account. In other embodiments, the system accesses the above-mentioned information upon the completion of the subject tax return. It should also be noted that in addition to verifying the genuineness of the user, the refund vehicle analyzer may be utilized to ensure that even a genuine user has not under-reported income, over-reported expenses and charitable donations, etc. The system may therefore be utilized to determine fraudulent tax returns, meaning that the tax return and user are genuine but reporting false or misleading information to the taxing authority.

In Step 618, the internal consistency analyzer collects information related to the information input to or appearing on the subject tax return. In essence, the internal consistency analyzer examines the subject tax return for internal consistencies and inconsistencies that may be indicative of fraud.

In Step 620, the internal consistency analyzer collects information related to the employer of the subject taxpayer. The internal consistency analyzer may also collect information related to an educational institution related to the subject taxpayer, non-employer sources of income (such as corporations paying dividends to stock holders), etc. The internal consistency analyzer compares the type and specific institution involved with the type and amount of income provided. The internal consistency analyzer determines the likelihood that the income source and income amount are genuine, because a common tax fraud strategy is to underreport income. Income types and amounts may be typical of some sources and not with others. In some instances, the internal consistency analyzer may access external information to verify the consistency of the information on the subject tax return.

In Step 622, the internal consistency analyzer considers whether the subject tax return appears to be consistent with any common tax fraud strategies employed by malfeasants. Many of these common fraud strategies have been discussed throughout the application. The internal consistency analyzer in essence has or accesses formulas and information indicative of exemplary fraudulent tax returns. The internal consistency engine then compares these formulas and/or exemplary fraudulent tax returns to look for similarities.

As an example, if the user has entered a disposable, temporary e-mail address, this is a likely indication that the user if a malfeasant. Legitimate subject taxpayers have an interest in providing a valid and continually monitored e-mail address to the taxing authority and/or the taxing professional, such that the entity can contact the subject taxpayer if an issue or concern arises. The internal consistency engine therefore analyzes the input e-mail address to determine whether it is of a type that is potentially disposable and temporary (e.g., belongs to a domain that is a known provider of temporary e-mails, the address is a seemingly random character string, etc.). An another example, the internal consistency engine may determine whether the phone number of the subject taxpayer is likely a temporary or false phone number (e.g., 123-456-7890), whether the address is a P.O. Box or likely a false address (e.g., 123 456^{th} St.), etc.

In Step 624, the internal consistency analyzer considers the claimed deductions and credits appearing on the subject tax return. Virtually all taxpayers qualify for some deductions and credits (including or in addition to the standard deduction). However, many fraudulent tax returns claim deductions and credits that are unrealistic in number and/or amount. In some embodiments, the internal consistency engine looks at the claimed deductions and credits and compares them to averages for the taxing authority. In some embodiments, the internal consistency engine determines a likelihood that the taxpayer does in fact qualify for the deductions and credits based upon external information, such as the account information accessed in Step 616 and known information about the subject taxpayer from previously filed tax returns. The internal consistency engine may also consider whether the deductions and credits are verifiable and whether the subject taxpayer previously claimed them (in similar amounts and sources).

In Step 626, the system compares the information retrieved in the above-mentioned steps with information regarding the subject taxpayer, the subject tax return and historical information. The historical information may be related to any or all of the above-discussed categories. Based upon the comparisons and/or the above-discussed steps, the system identifies confidence indicators. The above-mentioned characteristics of Step 516 apply equally to Step 626.

In some embodiments of Step 628, the indicator acquisition engine sends the confidence indicators (and in some cases the underlying information) to the indicator analysis engine for further analysis and comparison (as discussed above). In other embodiments of Step 628, the data entry analyzer calculates a data entry confidence score as discussed in Step 204, the refund vehicle analyzer calculates a refund vehicle confidence score as discussed in Step 206, and the internal consistency analyzer calculates an internal consistency confidence score as discussed in step 208. The respective indicator acquisition analyzers send their respective confidence scores to the indicator analysis engine in addition to (or in lieu of) the confidence indicators and underlying information. In still other embodiments, the indicator acquisition engine additionally calculates a peri-entry confidence score as discussed above and sends the peri-entry confidence score to the indicator analysis engine along with (or in lieu of) the confidence indicators, the underlying information, and/or the various confidence scores. ANALYSIS OF THE COMPLETED SUBJECT TAX RETURN

FIG. 7 briefly depicts exemplary methods in which the system determines confidence indicators based upon a completed or substantially completed subject tax return. The external historical consistency analyzer and the external lateral consistency analyzer compare the subject tax return with other external documents such as tax returns.

In Step 700 and Step 702 the system accesses or acquires tax information for a plurality of filed tax returns from a filed tax return data store. In Step 700, the plurality of filed tax returns retrieved includes tax returns for a plurality of different taxpayers (labeled “B”-“D”) for the current tax year (otherwise referred to herein as the “tax period”). In Step 702, the plurality of filed tax returns retrieved includes a plurality of tax returns for the subject taxpayer for previous tax years (labeled “2012”-“2014”).

In Step 704, the system receives or acquires tax information for a subject tax return that corresponds to a subject taxpayer (labeled “A”). The system compares the tax information for the subject tax return with the tax information for the plurality of filed tax returns. In Step 706, the system compares the identification information for the plurality of different taxpayers for the current tax year with the identification information for the subject taxpayer. Step 706 is attempting to determine confidence indicators among the tax returns (such as a duplicate Social Security Number) that may be indicative of fraud in one or more tax returns. In Step 708, the system compares the tax information for the subject tax return with the tax information for at least one previous tax year that corresponds to the subject taxpayer. Step 708 is attempting to determine indications that a malfeasant, rather than the subject taxpayer, is filing the subject tax return. Indications of this may include changes in the deposit account information, unusual family changes, unusual charitable donations, etc.

In Step 710, the system determines whether there are confidence indicators present. A confidence indicator in this context, as discussed below, is an anomalous, duplicative, or concerning relationship between at least two tax returns (referred to herein as the subject tax return and the “associated” tax return). The relationship could be a duplication, a similarity, a difference, an apparent error, or the like. If there are no detected duplications or similarities, this may also be a confidence indicator (i.e., the subject tax return is unique and therefore likely genuine).

FIG. 8 depicts another embodiment of the above-discussed steps in FIG. 7. In general, FIG. 8 is directed to an embodiment of the invention that receives a completed subject tax return and performs an analysis of the external historical consistency analyzer and the external lateral consistency analyzer. In some embodiments, the analysis of the internal consistency analyzer and the other analyzers may also be performed. It should be appreciated that the discussion of FIG. 8 is more detailed than, but fully applicable to, FIG. 7.

In Step 800, the system accesses, receives, or otherwise acquires tax information for the subject tax return. Based upon the entity that is utilizing the invention, as discussed above, the system may receive the tax information during preparation of the tax return, after completion of the tax return but prior to the filing process, after completion of the tax return at a time when filing is incipient, after transmission of the subject tax return to the taxing authority but before the taxing authority accepts the transmission, after transmission and acceptance of the subject tax return, within one minute of transmission and acceptance, within 24 hours of transmission and acceptance, within 72 hours of transmission and acceptance, etc. In some embodiments, the system receives the tax information upon a request by the user to print their electronic tax return for filing through the mail. In this way, users cannot circumvent the discussed steps by paper filing instead of filing electronically. The system may also contact the taxing authority to inform the taxing authority of the taxpayer identity confidence score associated with the subject tax return that will be filed through the mail. In addition, or in the alternative, the system may not allow the user to print the subject tax return if the taxpayer identity confidence score is below a certain threshold value, as discussed above.

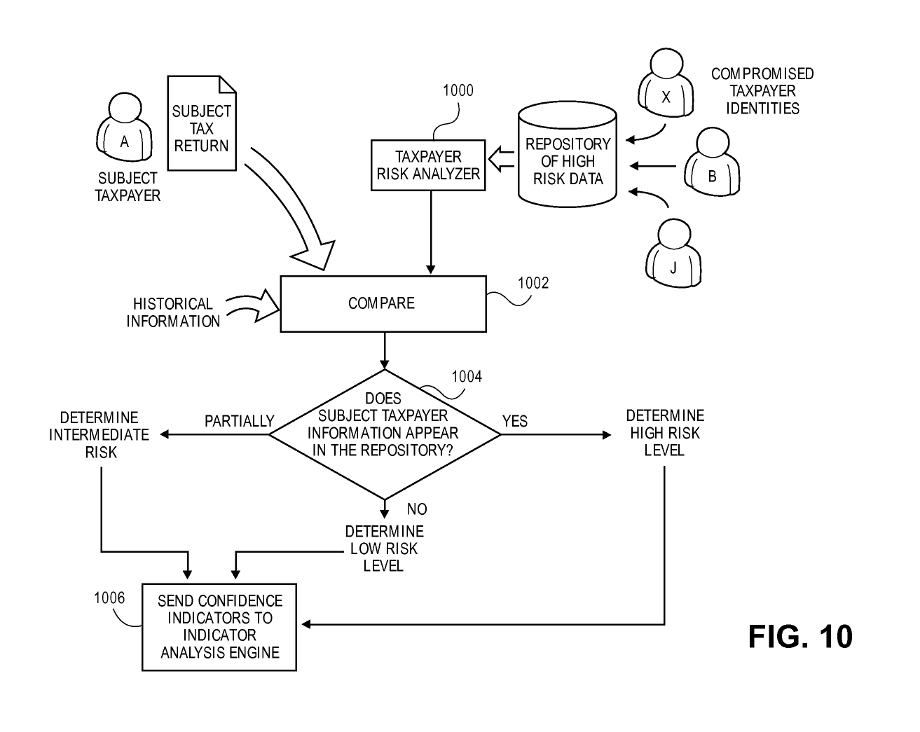

As discussed above, the subject tax return may be selected for authentication for any or all of numerous reasons, including: the client paid for the service, the service is provided as a value-added benefit to customers, the service is provided free of charge, the client has a high or moderate risk level for compromised information (as illustrated in FIG. 10 and discussed below), a certain number of tax returns are authenticated at random, there are other risk factors present in the subject tax return (such as being filed from out of the country), the subject taxpayer is a prior victim of tax fraud, etc.

Further, in some embodiments of Step 800, the system extracts tax information from the subject tax return. The tax information may include identification information for the subject taxpayer, income information for the subject taxpayer, expense information for the subject taxpayer, contact information for the subject taxpayer, information as to the total tax owed or refund expected, etc. In various embodiments of the invention, the system extracts any, some, or all of the enumerated categories of information. In other embodiments of the invention, the system receives the entire subject tax return and does not extract information therefrom.

In Steps 802 and 804, the system communicates with, downloads from, accesses, or otherwise acquires information stored in at least one filed return data store. The at least one filed return data store may be associated with any or all of the following: the tax professional, such that the filed return data store is a collection of at least some of the tax returns previously filed by the tax professional; the financial professional, such that the filed return data store is a collection of at least some of the tax returns for clients; the subject taxpayer, such that the previous tax returns of the subject taxpayer are stored by the subject taxpayer, such as on a personal computer; a plurality of tax professionals and/or financial professionals, such that the tax professionals and/or financial professionals share at least some of the information for their respective clients in a concerted effort to prevent fraud for all clients; the taxing authority, such that the taxing authority makes at least a portion of submitted tax returns for the current and/or previous years accessible to reputable tax professionals and/or financial professionals for fraud prevention; and/or a third party fraud prevention organization, such as a non-profit organization or government agency, that securely collects tax return information to be accessed by others for fraud prevention.

As mentioned above, the set of tax information for the previous tax returns may be located in, or associated with, more than one filed return data store. The filed return data stores may be associated with one another, separate and distinct, or both. The set of tax information for the previous tax returns may therefore be located in a plurality of locations. Nonetheless, the filed return data store is hereafter referred to in a singular manner. It should be appreciated that the filed return data store may include numerous disparate hardware (discussed more below).

As illustrated in FIG. 8, the filed return data store may include information from numerous sources. The filed return data store may include information for a plurality, a few, many, a plethora, substantially all, or all of the tax returns previously submitted for the current tax year (Step 802). The filed return data store may additionally, or in the alternative, include information for previous tax returns of the subject taxpayer (Step 804). The filed return data store may additionally, or in the alternative, include information for a plurality, a few, many, a plethora, substantially all, or all of the tax returns submitted for at least one previous tax year (not illustrated). The filed return data store may additionally, or in the alternative, include information (other than that on the respective tax returns) related to the respective taxpayers (not illustrated). For example, the filed return data store may include other identification information such as usernames and passwords, customer profiles, user accounts (discussed below), contact information (discussed below), etc.

In some embodiments, the system accesses tax returns of different taxing authorities in Step 802. For example, a common fraud strategy is for a malfeasant to submit a substantially similar tax return to each or many of the states in the United States that have a state income tax. Because the various states do not share information well, the malfeasant can receive tax returns from numerous states utilizing a largely duplicative tax return. Embodiments of the invention compare the subject tax return to the tax returns filed in a plurality of taxing authorities. Similarly, in some embodiments of Step 804, the system accesses the previously filed tax returns for the subject taxpayer related to a plurality of taxing authorities.

The system compares the set of tax information for the subject tax return with the set of tax information for the previous tax returns. Two exemplary comparisons are illustrated in Steps 806 and 808. Other comparisons may also be utilized. The comparisons attempt to identify confidence indicators as being present. The confidence indicators are indicative of possible, potential, likely, or definite fraud (or genuineness) in the subject tax return and/or at least one of the previous tax returns.

In Step 806, the system compares the tax information for the subject tax return with the tax information for the filed tax returns from the same tax period and associated with different taxpayers. In embodiments of Step 806, the system is attempting to identify duplicate identification information for the subject taxpayer. The duplicate identification information could include duplicate Social Security numbers, duplicate combinations of name and address, duplicate contact information, duplicate taxpayer identification numbers, etc. In addition or in the alternative, the system identifies duplicate information regarding the tax calculations. For example, it may be a confidence indicator if the income amounts and the charitable giving amounts are identical in two tax returns. Similarly, it may be a confidence indicator if the sources of normal income and the sources of capital gains income are identical in two tax returns (i.e. the malfeasant changing the identification information in each return but keeping the tax calculation information the same).

In Step 808, the system compares the tax information for the subject tax return with the tax information for the filed tax returns for the subject taxpayer for previous tax years. If the user has not provided, and the indicator acquisition engine has not located, filed tax returns for the subject taxpayer for the previous tax years, this may be assigned a negative confidence indicator (because most taxpayers have retained previous tax returns for audit purposes). In embodiments of Step 808, the system is attempting to identify anomalous, unexpected, unnatural, or otherwise suspicious changes in the tax returns for the subject taxpayer over the years.

For example, a change in deposit account information may be a negative confidence indicator. A common tactic of malfeasants is to submit a tax return that would be legitimate for the subject taxpayer in every way except for the deposit account information. The malfeasant submits the tax return and receives the tax refund in their bank account that is not associated with the subject taxpayer. As another example, a significant increase in the number and amount of tax deductions and credits may be a negative confidence indicator. These significant increases will likely lead to a larger tax refund, which may be an indication that the subject tax return is fraudulent (either filed by a malfeasant subject taxpayer or by a malfeasant posing as the subject taxpayer). As yet another example, unnatural family changes may be negative confidence indicators. While it is possible for a subject taxpayer to get married and have four children in the span of a tax year, such a significant change is unusual and may therefore be a confidence indicator. Significant family changes are indicative of fraud because they demonstrate that the user may be unfamiliar with the prior filed tax returns of the taxpayer. Similarly a change of employer without any income from the previous employer may be a negative confidence indicator. While it is possible that the subject taxpayer changed jobs, it is unlikely that the subject taxpayer did so immediately before or after the end of the tax year. Typically, the taxpayer will receive some compensation from the previous employer for the current tax year, or the new employer would have appeared on the previous tax return. An immediate change in employer of this nature is indicative that a malfeasant is producing fraudulent information on the subject tax return.

If the system does not detect any negative confidence indicators, the subject tax return may be verified (i.e. assigned a taxpayer identity confidence score above the above-discussed high threshold). The system may then allow the filing, continue the filing, or do nothing. The system may also notify the subject taxpayer, the tax professional, the financial professional, and/or the taxing authority.

It should be noted, however, that just because a subject tax return is so verified that does not mean the system is 100% certain that the subject tax return is genuine, only that the information and analysis available indicates genuineness. For example, a malfeasant may file a fraudulent tax return that assumes another's identity in January following a tax year, before many other tax returns have been filed for that tax year. Initially, this tax return is compared against the other returns for that year and may pass the verification. Then, in March, the taxpayer whose identity was assumed files their genuine tax return. At that time, the system detects confidence indicators. Based upon further analysis, the system may conclude that the previously-filed tax return was fraudulent and/or request authentication from the subject taxpayer. In this way, the fraud is detected and the taxing authority can take steps to cancel a pending tax refund for the malfeasant or attempt to retrieve an already issued tax refund to the malfeasant (such as from the malfeasant's bank account). The further steps of authentication and notification are discussed in depth below.

If the system does detect confidence indicators, the system proceeds to Step 810. In Step 810, the system retrieves the tax return or tax returns associated with the confidence indicators (referred to as the “associated tax return”). The system may retrieve the associated tax return in its entirety or extract portions of the associated tax return. In some embodiments, the system has already retrieved all or a portion of the associated tax return in Step 702, 802, and/or 804 above. In other embodiments, the system has only retrieved information indicative of the associated tax return, as provided by the filed tax return data store.

The system will then further analyze the subject tax return and/or the associated tax return to determine a taxpayer identity confidence score and which (if any, either, both, or all) of the tax returns is fraudulent. In essence, the system will attempt to determine whether the confidence indicator or indicators are actually indicative of fraud or whether they are innocuous errors and anomalies. As the system will in many instances not be able to determine this with 100% accuracy, the system may calculate a taxpayer identity confidence score. The system may in some instances determine within an allowable likelihood factor that the tax return is fraudulent or genuine. It should be appreciated that the following steps of FIG. 8 are exemplary and (as with any discussion of steps contained herein) any or all of the steps may be performed in any order.

In Step 812, the system determines whether the subject tax return and the associated tax returns are inadvertent or innocuous duplicate submissions. For example, if the subject and associated tax returns are submitted within 24 hours of each other, it is likely that the second submission was an inadvertent or innocuous duplicate submission by the subject taxpayer. This would be especially true if the two tax returns were actually or substantially identical. For example, the subject taxpayer may notice a typographical error in his recently submitted tax return, fix the error, and retransmit the tax return. As another example, if the subject taxpayer is two spouses, each spouse may inadvertently submit the subject tax return without knowledge that the other did so. As yet another example, the user may resubmit the subject tax return following a rejection by the taxing authority.

In Step 814, the system determines whether there are multiple confidence indicators and, if so, whether the multiple indicators are indicative of a common type of fraud. The system may also weigh and add the multiple confidence indicators in determining a taxpayer identity confidence score. If there are multiple confidence indicators, each indicative of a malfeasant assuming the identity of the subject taxpayer, the taxpayer identity confidence score is very low. If there are two confidence indicators, each indicative of disharmonious types of fraud, the taxpayer identity confidence score may be an intermediate value. If there are multiple confidence indicators, but each would be explainable and corroborate each other, then the taxpayer identity confidence score is high. For example, if the deposit account information, employer information, and address for the subject taxpayer have all changed, but have all changed to the same geographic location, it is likely that the subject taxpayer has taken a new job and moved. However, if the deposit account information, employer information, and address for the subject taxpayer have all changed, and have all changed to different geographic locations, the taxpayer identity confidence score may be very low.

In Step 816, the system determines the type of fraud indicated. As has been discussed throughout this application, there are numerous types of fraud which malfeasants use to receive an illegal tax return. A determination of the type of fraud indicated by the confidence indicator or indicators is instructive in determining a taxpayer identity confidence score and/or which if any is a legitimate return (as discussed below). Determining the type of fraud also allows for a more detailed analysis to determine if additional confidence indicators may be present.

In Step 818, the system attempts to determine which if any of the tax returns is genuine. Based upon the above analysis, the system may determine that the subject tax return and the associated tax returns are all fraudulent. For example, the system may decide that all returns are fraudulent if there are multiple tax returns using amalgamations of taxpayer identification information such as would indicate that the information was purchased from a repository of high risk information (discussed below). The system may also determine that both the subject tax return and the associated return are both genuine, as in the inadvertent duplicate submission scenario discussed above. In other instances, the computer program will determine or suspect that one of the tax returns is genuine and one is fraudulent. The system may then proceed to authenticate which of the tax returns is genuine, as discussed in much more detail below in the discussion of FIG. 9. It should also be appreciated that, as with any other step discussed herein, a human operator may assist in this step.

### Authentication of the User

FIG. 9 begins with Step 900, in which the system operates the user authentication analyzer. It should be appreciated that in embodiments, the user authentication operates before, during, after, or independently of the entry of information into the system. The system may also operate the user authentication analyzer more than one time during the preparation and submission of the tax return. For example, the system may operate the user authentication analyzer in a preliminary authentication in order to allow the user to access the system and later in a more complete authentication before submission of the tax return. It should also be appreciated that in embodiments of the invention will authenticate the user even wherein the system has determined a very high taxpayer identity confidence score. The authentication may be useful in future iterations of the system. For example, a first subject tax return is genuine and receives a high taxpayer identity confidence score upon filing. The system nonetheless authenticates the first subject tax return and the subject taxpayer. Later, a malfeasant files a second subject tax return using the identification information for the subject taxpayer. The system detects a confidence indicator and attempts to authenticate the malfeasant. Because the malfeasant is unable to successfully authenticate, and the first subject tax return was already authenticated, the system is able to correctly determine that the first subject tax return is genuine and the second subject tax return is fraudulent.

In Step 902, the system requests authentication from the user. As discussed above, the “user” is the entity that is using the system and/or the tax preparation program. The user may be the subject taxpayer, a malfeasant, the tax professional, the financial professional, an agent of the taxing authority, or a third party. The authentication steps therefore attempt to verify that the user is in fact the subject taxpayer or someone authorized by the subject taxpayer. As noted above, however, in some rare instances the subject taxpayer is a malfeasant. The malfeasant may also be able to pass the authentication due to an extensive identity theft. The authentication steps discussed below are therefore, in embodiments, indicative of the veracity of the various tax returns but not dispositive. In some embodiments, trusted users such as credentialed tax professionals can fully authenticate the subject tax return. This is especially true if the subject taxpayer is physically present with the trusted user.

In Step 904, the system determines whether there is pre-stored known authentication information associated with the subject taxpayer. In performing this step, the system may access other information known about the subject taxpayer, such as whether the subject taxpayer has an assigned taxpayer personal identification number (“taxpayer PIN”) from the taxing authority, a taxpayer PIN from the tax professional or financial professional, whether the taxpayer has pre-stored known user name and password, whether the taxpayer has a pre-stored known e-mail address, or whether the taxpayer has other electronic credentials. These items of authentication information may be accessed from a subject taxpayer account (discussed below), from the filed tax return data store, from the taxing authority, from a third party (such as a financial institution associated with the subject taxpayer), etc.

If the system determines that there is pre-stored known authentication information for the subject taxpayer, in step 906 the system prompts the user to enter the authentication information. The prompt may appear on a graphical user interface (GUI) of the tax preparation program, on a GUI of the system, in an electronic communication to the user, etc. The prompt may include at least one field into which the user can enter the authentication information. In other embodiments, the prompt may direct the user to another electronic resource into which the user can enter the electronic information. Authentication may be performed by requiring the taxpayer to submit a pre-registered unique identifier associated with the taxpayer, by submitting the taxpayer's tax identification number, by submitting biometric indicia of the subject taxpayer, by submitting a photograph of the subject taxpayer, by submitting a photograph of an identification card (such as a driver's license) issued to the subject taxpayer, by entry of “out of wallet” (i.e. not easily accessible and stolen) information, or by other known authentication techniques.

Upon receipt of the input authentication information from the user, in Step 908 the system determines whether the entered authentication information matches the pre-stored known authentication information for the subject taxpayer. In some embodiments, the system transmits the input authentication information to an external electronic resource for authentication. For example, the system may have information that the subject taxpayer has an assigned taxpayer PIN but not actually know what the taxpayer PIN is. The system, in this example, may submit the entered authentication information to the taxing authority so that the taxing authority can compare the entered authentication information with the pre-stored known authentication information. The taxing authority, in this example, may then send a communication to the system indicative of whether the entered authentication information matches the pre-stored known authentication information.

If the entered authentication information and the pre-stored known authentication information do not match, in some embodiments of the invention the system may allow a limited number of reentry attempts in Step 910. Each reentry attempt is then verified as discussed above in Step 908.

If the entered authentication information does match the pre-stored known authentication information, in Step 916 the system sends the confidence indicators to the indicator analysis engine. However, if the associated tax return was also previously authenticated via the same or similar authentication information for the subject taxpayer, there is a possibility that both the subject tax return and the associated tax return are both fraudulent and that a malfeasant has acquired the authentication information for the subject taxpayer. In this instance, the system may flag both returns as potentially fraudulent and submit them for further review by the system and/or a human operator. In the more likely scenario in which the associated tax return has not been previously authenticated, the system marks the associated tax return as potentially or definitely fraudulent, based upon the taxpayer identity confidence score discussed above.

In some embodiments, the subject taxpayer is notified of the fraudulent associated tax return. The notification may include information indicative of the associated tax return to assist in locating the associated return by the taxing authority and/or law enforcement (as discussed above). In some embodiments of the invention, the system notifies the subject taxpayer of a successful authentication. In this way, if the authenticated subject tax return is in fact fraudulent, this will alert the subject taxpayer to investigate (i.e. if the subject taxpayer did not file or authorize the subject tax return).

The subject taxpayer is notified via a set of contact information. Contact information represents a method of reaching the subject taxpayer. Much of the taxpayer's contact information is listed on the subject tax return (assuming the subject tax return is genuine). The computer program or tax professional may query the taxpayer before, during, or after the tax preparation process to receive contact information. In other embodiments, the computer program may access previously stored contact information for the subject taxpayer or previous tax returns for the taxpayer. Examples of contact information include, but are not limited to, home address, work address, home phone number, cell phone number, e-mail address, and social media account, such as a FACEBOOK™ account or a TWITTER™ handle.

If there is no pre-stored known authentication information, the system may attempt a secondary authentication in Step 912. In embodiments of the invention, Step 912 consists at least in part of a questionnaire regarding the subject tax return that is presented to the user. The system may generate a combination of easy and difficult questions that the user would know the answer to, if the user is in fact the subject taxpayer or someone authorized by the subject taxpayer. As with Step 906, the questionnaire may be displayed on a GUI of the tax preparation program, a GUI of the system, in a separate electronic communication, etc.

The system may generate the questionnaire or may generate the values as the answers to the questionnaire. Examples of questions from the questionnaire include the last 3 digits of bank account where the refund was deposited for a certain prior year's tax return, which employer paid the most money for a certain prior year's tax return, last 4 digits on the spouse's SSN, Date of birth for the spouse, how old is the oldest claimed dependent, primary e-mail address, last 4 digits of credit card used to pay for tax services for a specific previous tax year, subject taxpayer's mother's maiden name, etc.

In Step 918, the system determines if the answers received from the user are satisfactory. In some embodiments, the user must correctly answer all questions to be satisfactory. In other embodiments, the user may miss one or more answers and still be satisfactory. The system determines if the answers by comparing the received answers to pre-stored known information upon which the question was based. The pre-stored known information could be from a tax return for the subject taxpayer for a previous year. These questions are advantageous because a malfeasant will likely not have access to previous tax returns for the subject taxpayer. The pre-stored known information may be based upon other information known about the subject taxpayer based upon a taxpayer account or other interactions.

Another form of secondary authentication may be by prompting the user for credentials to at least one trusted electronic resource. For example, the user may be prompted to enter FACEBOOK™, TWITTER™, and other social media credentials. The system would then log into these sites to match a name associated with the account with the subject taxpayer's name. The system may also attempt to determine how genuine the account is, whether the account has been independently verified, etc. For example, a FACEBOOK™ account may contain numerous verifiable sets of data with regard to the subject taxpayer. If the user provides the credentials for the account, this may be indicative that the user is the subject taxpayer. However, this form of secondary authentication may be less reliable than others and therefore may produce a confidence indicator of a smaller magnitude, because a malfeasant could have illegally acquired the login information or created an imitation social media account.

Another form of secondary authentication invites the user to enter biometric data even if there is no previously stored known value for the subject taxpayer. In this scenario, the user is invited to use a fingerprint scanner attached to the user computing device even if the system does not have information so as to identify the subject taxpayer. Malfeasants would be unlikely to enter this information because it could potentially be used as evidence against them in a subsequent criminal proceeding. The entered biometric data could also be compared to a data store of other entered biometric data to determine additional confidence indicators based on its duplicity or uniqueness.

### Taxpayer Risk Level

Turning to FIG. 10, embodiments of the invention analyze the subject taxpayer to determine risk level for fraud. In some embodiments, this analysis is performed during a tax year to anticipate the likelihood that fraud will be attempted against the subject taxpayer in the coming tax return season following the end of the tax year. Performing this analysis early gives warning to the subject taxpayer and allows them to file their tax return as soon as possible, and take other steps such as setting up a taxpayer PIN, to avoid fraud. In some embodiments, this analysis is performed in conjunction with the calculation of a taxpayer identity confidence score discussed above. For example, if the associated tax return includes a duplicate SSN, the system may perform the analysis described in FIG. 10 to determine if it is likely that the SSN was purchased or acquired through illegal means. The presence of the SSN in the repository of high risk data makes it much more likely that at least one of the tax returns is fraudulent.

In Step 1000, the system accesses a repository of high-risk data. This repository is in essence a fraud “black market” in which malfeasants purchase and exchange taxpayer identities and the like. A repository may include any of data stores, electronic resources, files, servers, and the like. The repository contains at least some identification information for compromised taxpayer identities. The compromised taxpayer identities may be indicative of some of the same taxpayers for which the filed return data store relates. The compromised taxpayer identities may also include the identities of recently deceased persons, legally incapacitated persons, persons living abroad, persons in the military that are currently deployed, etc. These classifications of persons are unlikely to file a legitimate tax return, therefore they are prime targets for fraud. The repository may be associated with the system and periodically update, such that all or substantially all high-risk data is consolidated in one easily searched location.

In Step 1002, the system compares the subject tax return and the subject taxpayer to the data retrieved from the repository of high-risk data. The system compares the identification information, and other information, against that found in the repository.

In addition or alternatively, embodiments of the invention may perform statistical analyses or modeling of each taxpayer's tax information and compare to known types of information indicative of identify theft. For example, taxpayers with one or more of the following tax information indicia are at an increased likelihood of identity theft: a certain age group, earned income tax credit status, race, zip code, and gender. To be clear, the above is only a list of high-risk factors. Embodiments of the invention analyze the various tax information items associated with the taxpayer, compare the tax information for a particular taxpayer to known risk factors for identity theft, and determine a correlation factor between a particular taxpayer's tax information and the risk factors.

In Step 1004, the system determines whether the identification information for the subject taxpayer appears in the repository of high-risk information and/or if the other indicia of increased likelihood of identity theft are present. Based upon whether all, some, or none of the information if present, the system assigns a risk level to the subject taxpayer.

In some embodiments, the system also accesses a credit score or a credit report of the subject taxpayer from a credit-reporting organization. The system may determine if there is a hold on the credit report (indicating that the subject taxpayer has been the past victim of identity theft), whether there are indications of identity theft on the credit report, whether the credit-reporting organization has any records of identity theft related to the subject taxpayer, etc. The system may also consider the credit worthiness of the subject taxpayer.

In some embodiments, the system accesses or receives information from the taxing authority regarding activity indicative of the subject taxpayer. For example, the IRS keeps a log of all tax documents received related to the subject taxpayer, tax amounts paid and owed, refund amounts, etc. Some tax documents are received from employers (e.g. W2s) and other income sources (e.g. 1099s). Some tax documents are received from the subject taxpayer. Some tax documents are issued by the taxing authority, such as notice documents. The tax documents, and the accompanying log, may relate to current and/or previous tax years. The taxing authority utilizes the log and tax documents in reviewing the subject tax return for fraud. In some embodiments, the taxing authority shares this information with the system, or will verify information for the system upon request. This allows the system to perform authentication on behalf of the taxing authority, so as to reduce the authentication burden on the taxing authority and allow the system to prevent the filing of fraudulent tax returns. The log and tax documents can be utilized by the system as historical information in the determination of confidence indicators. The system may also monitor or periodically review the log and tax documents in the determination of confidence indicators.

In some embodiments, the subject taxpayer can create an account with the taxing authority to have access to these documents. In some embodiments, the tax professional or financial professional can receive authentication from the subject taxpayer and the taxing authority to access these documents. In some embodiments, the subject taxpayer can share their credentials with the tax professional such that the tax professional (and therefore embodiments of the system) can access these documents.

### Additional Embodiments

Some embodiments of the invention assist the subject taxpayer in correcting fraud and dealing with the consequences thereof. For example, if the subject taxpayer is determined to be the victim of fraud as described above, the system may alert one of more credit organizations to inform them of the fraud. The system may also alert any relevant insurance company or credit card company. The system may also contact the bank for which the malfeasant selected as his deposit account, to inform that bank that their accounts are being used for fraudulent purposes. The bank may also be able to identify the malfeasant and put a hold on or close the account such that no other ill-gotten tax refunds are deposited therein.

While the disclosure has heretofore referred to taxing authorities, tax returns, and taxpayers. It should be appreciated that in other embodiments, the invention is directed to government entities other than taxing authorities, such as an administrative agency, or to companies or other organizations. The administrative agency may be associated with a government entitlement program, such as the Social Security Administration or Medicaid. The administrative agency may additionally, or in the alternative, be associated with a regulatory program, such as the Environmental Protection Agency or the Securities and Exchange Commission. The company or organization may be associated with or performing the functions of, a government entity, or it may be a for-profit or not-for-profit entity unrelated to the government. For example, the government entity or company may receive and process claim forms and the like that would be subject to fraud.

In these embodiments, the “taxpayer” may instead be a “beneficiary,” a “citizen,” a “customer,” a “third party,” etc. While most of the present disclosure is directed to the field of taxes, this is only an exemplary field of use. For example, if the “taxing authority” is the Social Security Administration, then the “taxpayer” would be referred to as a “beneficiary.” This disclosure is therefore not intended to be limiting, but instead provide an easy-to-understand exemplary embodiment of the invention.

Other embodiments of the system will now be discussed. The system of embodiments may comprise various engines and analyzers for performing the above-discussed steps, additionally or alternatively to the above discussed engines and analyzers. Some embodiments of the invention comprise a return verification engine that acquires subject tax information indicative of a subject tax return to be verified. The return verification engine accesses the filed tax information associated with the current tax period from the filed return data store. The return verification engine compares the subject tax information to the filed tax information to identify at least one confidence indicator.

Some embodiments of the system further comprise an authentication engine for requesting, from the user, authentication information associated with the subject taxpayer to authenticate the subject taxpayer and comparing the received authentication information with a pre-stored known authentication information associated with the subject taxpayer to authenticate the subject tax return as properly associated with the subject taxpayer.

Some embodiments of the system further comprise a notification engine for notifying the user, using a set of taxpayer identification information associated with the subject taxpayer, of the fraudulent tax return.

Some embodiments of the system further comprise a risk analysis engine for accessing the repository of high-risk data that includes information indicative of a plurality of taxpayers whose identification information has been compromised. The risk analysis engine determines a risk level associated with the subject taxpayer by comparing the subject taxpayer identification information to the accessed information from the repository of high-risk data.

### System Hardware

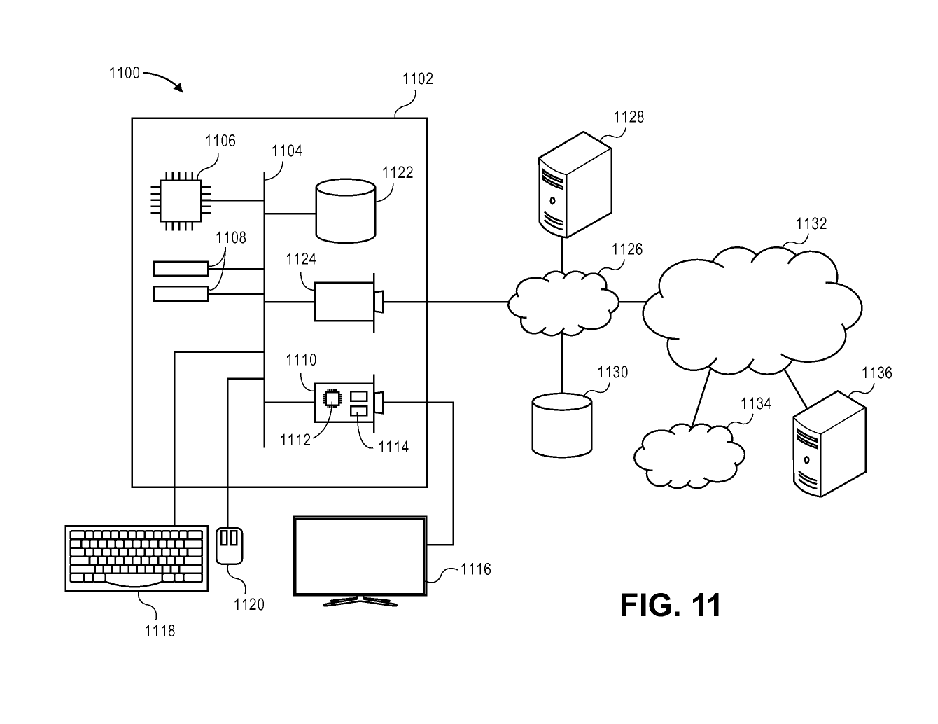

Turning to FIG. 11, the physical hardware that makes up the system will now be discussed. The system 1100 comprising an exemplary hardware platform that can form one element of certain embodiments of the invention is depicted. Computer 1102 can be a desktop computer, a laptop computer, a server computer, a mobile device such as a smartphone or tablet, or any other form factor of general- or special-purpose computing device. Depicted with computer 1102 are several components, for illustrative purposes. In some embodiments, certain components may be arranged differently or absent. Additional components may also be present. Included in computer 1102 is system bus 1104, whereby other components of computer 1102 can communicate with each other. In certain embodiments, there may be multiple busses or components may communicate with each other directly. Connected to system bus 1104 is central processing unit (CPU) 1106. Also attached to system bus 1104 are one or more random-access memory (RAM) modules 1108.

Also attached to system bus 1104 is graphics card 1110. In some embodiments, graphics card 1104 may not be a physically separate card, but rather may be integrated into the motherboard or the CPU 1106. In some embodiments, graphics card 1110 has a separate graphics-processing unit (GPU) 1112, which can be used for graphics processing or for general purpose computing (GPGPU). Also on graphics card 1110 is GPU memory 1114. Connected (directly or indirectly) to graphics card 1110 is display 1116 for user interaction. In some embodiments no display is present, while in others it is integrated into computer 1102. Similarly, peripherals such as keyboard 1118 and mouse 1120 are connected to system bus 1104. Like display 1116, these peripherals may be integrated into computer 1102 or absent. Also connected to system bus 1104 is local storage 1122, which may be any form of computer-readable media, and may be internally installed in computer 1102 or externally and removably attached.

Finally, network interface card (NIC) 1124 is also attached to system bus 1104 and allows computer 1102 to communicate over a network such as network 1126. NIC 1124 can be any form of network interface known in the art, such as Ethernet, ATM, fiber, Bluetooth, or Wi-Fi (i.e., the IEEE 802.11 family of standards). NIC 1124 connects computer 1102 to local network 1126, which may also include one or more other computers, such as computer 1128, and network storage, such as data store 1130. Local network 1126 is in turn connected to Internet 1132, which connects many networks such as local network 1126, remote network 1134 or directly attached computers such as computer 1136. In some embodiments, computer 1102 can itself be directly connected to Internet 1132.

### Computer Program

The computer program of embodiments of the invention comprises a plurality of code segments executable by the computing device for performing the steps of various methods of the invention. The steps of the method may be performed in the order discussed, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof using the system, which broadly comprises server devices, computing devices, and a communication network.

The computer program of embodiments of the invention may be responsive to user input. As defined herein user input may be received from a variety of computing devices including but not limited to the following: desktops, laptops, calculators, telephones, smartphones, or tablets. The computing devices may receive user input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like.

The server devices and computing devices may include any device, component, or equipment with at least one processing element and at least one memory element. The processing element may implement operating systems, and may be capable of executing the computer program, which is also generally known as instructions, commands, software code, executables, applications (“apps”), and the like. The at least one processing element may comprise processors, microprocessors, microcontrollers, field programmable gate arrays, and the like, or combinations thereof. The at least one memory element may be capable of storing or retaining the computer program and may also store data, typically binary data, including text, databases, graphics, audio, video, combinations thereof, and the like. The at least one memory element may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to the at least one memory element, the server devices may further include file stores comprising a plurality of hard disk drives, network attached storage, or a separate storage network.

The computing devices may specifically include mobile communication devices (including wireless devices), work stations, desktop computers, laptop computers, palmtop computers, tablet computers, portable digital assistants (PDA), smart phones, smart watches, wearable technology, and the like, or combinations thereof. Various embodiments of the computing device may also include voice communication devices, such as cell phones and/or smart phones. In preferred embodiments, the computing device will have an electronic display operable to display visual graphics, images, text, etc. In certain embodiments, the computer program facilitates interaction and communication through a graphical user interface (GUI) that is displayed via the electronic display. The GUI enables the user to interact with the electronic display by touching or pointing at display areas to provide information to the system.

The communication network may be wired or wireless and may include servers, routers, switches, wireless receivers and transmitters, and the like, as well as electrically conductive cables or optical cables. The communication network may also include local, metro, or wide area networks, as well as the Internet, or other cloud networks. Furthermore, the communication network may include cellular or mobile phone networks, as well as landline phone networks, public switched telephone networks, fiber optic networks, or the like.

Embodiments of the invention directed to the computer program may perform any or all of the above-discussed steps. The computer program may run on computing devices or, alternatively, may run on one or more server devices. In certain embodiments of the invention, the computer program may be embodied in a stand-alone computer program (i.e., an “app”) downloaded on a user's computing device or in a web-accessible program that is accessible by the user's computing device via the communication network. As used herein, the stand-along computer program or web-accessible program provides users with access to an electronic resource from which the users can interact with various embodiments of the invention.

In embodiments of the invention, users may be provided with different types of accounts. Each type of user account may provide their respective users with unique roles, capabilities, and permissions with respect to implementing embodiments of the invention. For instance, the taxpayer may be provided with a taxpayer account that permits the taxpayer to access embodiments of the invention that are applicable to submitting and authenticating their tax return. Additionally, the tax professional or financial professional may be provided with a tax/financial professional account that permits the tax professional or financial professional to access embodiments of the invention that are applicable to accessing the filed return data store, verifying their customer, etc. In addition, any number and/or any specific types of account are provided to carry out the functions, features, and/or implementations of the invention. Upon the taxpayer, third party, tax professional, and/or financial professional logging in to the electronic resource for a first time, they may be required to provide various pieces of identification information to create their respective accounts. Such identification information may include, for instance, personal name, business name, email address, phone number, or the like. Upon providing the identification information, the taxpayer, third party, and/or tax professional may be required to enter (or may be given) a username and password, which will be required to access the electronic resource.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium having a computer program stored thereon for detecting a fraudulently filed tax return, wherein the computer program instructs at least one processing element to perform the following steps:
receiving tax information associated with a subject tax return for a subject taxpayer;
accessing a filed return data store comprising tax information associated with a plurality of previously filed tax returns for a respective plurality of taxpayers,
wherein each of the plurality of previously filed tax returns is associated with a tax period that is the same as a tax period associated with the subject tax return for the subject taxpayer;
comparing the received tax information associated with the subject tax return for the subject taxpayer with said accessed tax information from the filed return data store; and
identifying, based on said comparison, at least one confidence indicator for the subject tax return,
wherein said at least one confidence indicator is indicative of a whether the subject tax return is genuine.

2. The computer-readable storage medium of claim 1, wherein the computer program instructs the at least one processing element to perform the step of notifying the subject taxpayer of the fraudulent tax return upon a determination that the subject tax return is likely fraudulent.

3. The computer-readable storage medium of claim 1, wherein said at least one confidence indicator comprises a common set of taxpayer identification information between a set of subject taxpayer identification information for the subject tax return and a set of filed taxpayer identification information associated with the plurality of previously filed tax returns.

4. The computer-readable storage medium of claim 3, wherein the computer program instructs the at least one processing element to perform the following steps:
accessing a repository of high-risk data that includes information indicative of a plurality of taxpayers whose identification information has been compromised; and
determining a risk level associated with the subject taxpayer by comparing the subject taxpayer identification information to the accessed information from the repository of high-risk data.

5. The computer-readable storage medium of claim 4, wherein the computer program further instructs the at least one processing element to perform the steps of:
requesting, from the subject taxpayer, authentication information associated with the subject taxpayer to authenticate the subject taxpayer;
receiving, from the subject taxpayer, said authentication information; and
comparing the received authentication information with a pre-stored known authentication information associated with the subject taxpayer to authenticate the subject tax return as properly associated with the subject taxpayer.

6. The computer-readable storage medium of claim 5,
wherein the received tax information associated with the subject tax return for the subject taxpayer comprises subject taxpayer identification information that identifies the subject taxpayer,
wherein the accessed tax information associated with the plurality of previously filed tax returns for the respective plurality of taxpayers is filed taxpayer identification information that identifies each of the respective plurality of taxpayers.

7. The computer-readable storage medium of claim 1, wherein the computer program further instructs the at least one processing element to perform the following steps:
accessing a previously filed tax return associated with the subject taxpayer for at least one previous tax period;
comparing said received tax information associated with the subject tax return for the subject taxpayer with said at least one accessed previously filed tax return for the subject taxpayer for the at least one previous tax period; and
identifying, based on said comparison, said at least one confidence indicator between the subject tax return and said at least one accessed previously filed tax return for the subject taxpayer for at least one previous tax period.

8. The computer-readable storage medium of claim 7, wherein said at least one confidence indicator is a change in a bank deposit account from the previously filed tax return to the subject tax return.

9. A computerized method for detecting fraudulently filed tax returns, the method comprising the following steps:
receiving tax information associated with a subject tax return for a subject taxpayer;
accessing a filed return data store comprising tax information associated with a plurality of previously filed tax returns for a respective plurality of taxpayers,
wherein the each of the plurality of previously filed tax returns is associated with a tax period that is the same as a tax period associated with the subject tax return for the subject taxpayer;
comparing the received tax information associated with the subject tax return for the subject taxpayer with said accessed tax information from the filed return data store; and
identifying, based on said comparison, at least one confidence indicator for the subject tax return,
wherein said at least one confidence indicator is indicative of a fraudulent tax return for the subject taxpayer.

10. The computerized method of claim 9, wherein the computer program instructs the at least one processing element to perform the step of notifying the subject taxpayer of the fraudulent tax return.

11. The computerized method of claim 9, wherein said at least one confidence indicator comprises a common set of taxpayer identification information between a set of subject taxpayer identification information for the subject tax return and a set of filed taxpayer identification information associated the plurality of previously filed tax returns.

12. The computerized method of claim 11, wherein the computer program instructs the at least one processing element to perform the following steps:
accessing a repository of high-risk data that includes information indicative of a plurality of taxpayers whose identification information has been compromised; and
determining a risk level associated with the subject taxpayer by comparing the subject taxpayer identification information to the accessed information from the repository of high-risk data.

13. The computerized method of claim 12, wherein the computer program further instructs the at least one processing element to perform the steps of:
requesting, from the subject taxpayer, authentication information associated with the subject taxpayer to authenticate the subject taxpayer;
receiving, from the subject taxpayer, said authentication information; and
comparing the received authentication information with a pre-stored known authentication information associated with the subject taxpayer to authenticate the subject tax return as properly associated with the subject taxpayer.

14. The computerized method of claim 13,
wherein the received tax information associated with the subject tax return for the subject taxpayer comprises subject taxpayer identification information that identifies the subject taxpayer,
wherein the accessed tax information associated with the plurality of previously filed tax returns for the respective plurality of taxpayers is filed taxpayer identification information that identifies each of the respective plurality of taxpayers.

15. The computerized method of claim 9, wherein the computer program further instructs the at least one processing element to perform the following steps:
accessing a previously filed tax return associated with the subject taxpayer for at least one previous tax period;
comparing said received tax information associated with the subject tax return for the subject taxpayer with said at least one accessed previously filed tax return for the subject taxpayer for the at least one previous tax period; and
identifying, based on said comparison, said at least one confidence indicator between the subject tax return and said at least one accessed previously filed tax return for the subject taxpayer for at least one previous tax period.

16. The computerized method of claim 15, wherein said at least one confidence indicator is a change in a bank deposit account from the previously filed tax return to the subject tax return.

17. A system for detecting a fraudulent tax return, the system comprising:
a filed return data store comprising filed tax information indicative of a plurality of previously filed tax returns for a corresponding plurality of filed taxpayers;
an indicator acquisition engine that receives subject tax information indicative of a subject tax return to be verified,
wherein the subject tax return is associated with a tax period,
wherein the indicator acquisition engine accesses the filed tax information associated with said tax period from the filed return data store,
an indicator analysis engine for comparing the subject tax information to the filed tax information to identify at least one confidence indicator,
wherein said at least one confidence indicator is indicative of a fraudulent tax return related to the subject taxpayer.

18. The system of claim 17, further comprising:
an authentication engine for requesting, from a user, authentication information associated with the subject taxpayer to authenticate the subject taxpayer and comparing the received authentication information with a pre-stored known authentication information associated with the subject taxpayer to authenticate the subject tax return as properly associated with the subject taxpayer.

19. The system of claim 17, further comprising:
a notification engine for notifying a user, using a set of taxpayer identification information associated with the subject taxpayer, of the fraudulent tax return.

20. The system of claim 17, further comprising:
a risk analysis engine for accessing a repository of high-risk data that includes information indicative of a plurality of taxpayers whose identification information has been compromised,
said risk analysis engine determining a risk level associated with the subject taxpayer by comparing the subject taxpayer identification information to the accessed information from the repository of high-risk data.
